(19) United States
(12) Patent Application Publication
(10) Pub. No.: US 2024/0187867 A1
(43) Pub. Date: Jun. 6, 2024

(54) Beamformed Radio Communication Technique

(71) Applicant: Telefonaktiebolaget LM Ericsson (publ), Stockholm (SE)

(72) Inventors: Yuhang Liu, Lund (SE); Tai Do, Lund (SE); Peter Alriksson, Hörby (SE); Narendar Madhavan, Bara (SE)

(21) Appl. No.: 18/285,455

(22) PCT Filed: Apr. 6, 2022
(86) PCT No.: PCT/SE2022/050346

§ 371 Date: Oct. 3, 2023

Related U.S. Application Data
(60) Provisional application No. 63/171,484, filed on Apr. 6, 2021.

(51) Int. Cl. H04W 16/14; H04B 7/06; H04W 74/0808

(52) U.S. Cl. CPC H04W 16/14; H04B 7/0617; H04W 74/0808

(57) ABSTRACT

A technique for performing a beamformed transmission on shared radio spectrum at a transmitting station (100) is described. As to a method aspect of the technique performed by a user equipment, UE (100), as the transmitting station (100), beamforming weights, for a beamformed reception (502) of a clear channel assessment, CCA (302), and the beamformed transmission (304), are determined based on a source channel (506) or a source signal (506). The CCA (302) is performed on the shared radio spectrum using an antenna array of the transmitting station (100), wherein the CCA (302) comprises the beamformed reception (502) on the shared radio spectrum at the UE (100) prior to the beamformed transmission (304). Depending on a result of the CCA, the beamformed transmission (304) on the shared radio spectrum is performed using the antenna array from the UE (100) to a receiving station (200; 800; 912; 1020; 1030).

### TECHNICAL FIELD

The present disclosure relates to a technique for beamformed radio communication on shared radio spectrum such as unlicensed spectrum or millimeter wave frequency bands. More specifically, and without limitation, methods and devices are provided for performing and configuring a beamformed transmission on shared radio spectrum.

### BACKGROUND

The Third Generation Partnership Project (3GPP) specified New Radio (NR) as a Fifth Generation (5G) radio access technology (RAT) in the frequency range below 7 GHz and above 7 GHz, e.g., in the millimeter wave frequency bands or above 50 GHz. The operation of NR includes Licensed-Assisted Access (LAA) and unlicensed operation (NR-U), in which case the radio spectrum may be shared with other RATs.

The research publication “LBT Switching Procedures for New Radio-based Access to Unlicensed Spectrum” by Sandra Lagen, Lorenza Giupponi, and Natale Patriciello at the Centre Tecnológic de Telecomunicacions de Catalunya (CTTC/CERCA), Barcelona, Spain, published in 2018 IEEE Globecom Workshops (GC Wkshps), Abu Dhabi, United Arab Emirates, 2018, pp. 1-6 (doi: 10.1109/GLOCOMW.2018.8644176) proposes a listen before talk (LBT) switching procedures for new radio (NR) beam-based access to unlicensed mmWave bands, in which the type of physical carrier sense at gNBs as the transmitting nodes is dynamically adjusted between directional LBT (dirLBT) and omnidirectional LBT (omniLBT) according to environment observations.

3GPP RAN1 has agreed, particularly under a work item (WI) of “Support NR from 52.6 to 71 GHz” for release 17, that LBT operation is supported, e.g., at least when it is mandated by regional regulations.

### SUMMARY

Accordingly, there is a need for an LBT technique that takes physical characteristics of a radio channel and/or large antenna arrays for radio frequencies greater than 50 GHz or in the millimeter wave frequency bands into account.

As to a first method aspect, a method of performing a beamformed transmission on shared radio spectrum at a transmitting station is provided. The method performed by a user equipment (UE) as the transmitting station comprises a step of performing a clear channel assessment (CCA) on the shared radio spectrum using an antenna array of the UE, wherein the CCA comprises a beamformed reception on the shared radio spectrum at the UE prior to the beamformed transmission. The method further comprises a step of depending on a result of the CCA, selectively performing the beamformed transmission on the shared radio spectrum using the antenna array from the UE to a receiving station.

In any aspect, by performing the CCA on the shared radio spectrum using the antenna array that is also used for the subsequent beamformed transmission, at least some embodiments can used radio resources (e.g., based on spatial diversity) more efficiently in the coexistence of multiple RATs using the shared radio spectrum.

The method may further comprise a step of indicating a capability of beam correspondence.

Alternatively or in addition, the method may further comprise a step of determining beamforming weights for the beamformed reception of the CCA and the beamformed transmission based on a source channel or a source signal.

The CCA may be performed at the transmitting station. Alternatively or in addition, the beamformed transmission may be performed at the transmitting station.

The CCA may be performed immediately before the beamformed transmission.

The result of the CCA may be indicative of whether the shared radio spectrum is occupied (i.e., busy) or unoccupied (i.e., idle).

The CCA may be part of a listen before talk (LBT) procedure. The LBT procedure may comprise initializing a backoff counter when the transmitting station has data for the beamformed transmission. If the result of the CCA indicates that the shared radio spectrum is unoccupied during a defer period, the LBT procedure may comprise decreasing the backoff counter every idle slot duration if the result of the CCA indicates that the shared radio spectrum is unoccupied during the idle slot duration.

The CCA may also be referred to as channel sensing. The shared radio spectrum may also be referred to as a shared radio channel (or briefly: shared channel or more briefly: channel).

The beamformed transmission may be performed responsive to (e.g., the result of) the CCA indicating that the shared radio spectrum is unoccupied and/or a backoff counter is equal to zero. Alternatively or in addition, according to the selectivity of the step of performing the beamformed transmission, the transmitting station may refrain from (e.g., defer and/or backoff from) the beamformed transmission, e.g., responsive to (e.g., the result of) the CCA indicating that the shared radio spectrum is occupied and/or a backoff counter is not yet equal to zero.

The transmitting station may use beam correspondence. Alternatively or in addition, the beamforming transmission may be an uplink transmission and the CCA for the uplink transmission may be performed by a radio device as the transmitting station with beam correspondence capability.

The beam correspondence may be a capability of the UE that the UE indicates to a network node via capability reporting. Alternatively or in addition, the UE may indicate the capability of the beam correspondence by transmitting a control signaling to a network node.

The beamformed reception may also be referred to as beamformed sensing. For example, the beamformed reception does not require that data or control signaling is successfully received (e.g., successfully decoded).

The shared radio spectrum may be sensed according to the CCA in the beamformed reception. In other words, the beamformed reception may sense the shared radio spectrum during the CCA. In still other words, the CCA may be spatially restricted according to the beamformed reception.

Herein, “beamformed” (e.g., in a beamformed reception and/or a beamformed transmission) may refer to a gain depending on direction (i.e., a gain having a directional dependency), e.g., as viewed from the antenna array. For example, the beamformed reception may refer to a receiver gain depending on direction, e.g., a directional sensitivity of the antenna array used for the CCA. Alternatively or in addition, the beamformed transmission may refer to a transmitter gain depending on direction, e.g., a directional energy flux (i.e., the energy transfer per unit area per unit time) of an electromagnetic field transmitted from the antenna array during the beamformed transmission.

The directional dependency of the gain may correspond to an angular dependency. Alternatively or in addition, the directional dependency of the gain may comprise an azimuthal dependency (i.e., a horizontal angular dependency) and/or a dependency on inclination (i.e., a vertical angular dependency).

The beamformed reception may be omni-directional or quasi-omni-directional. Alternatively or in addition, a reception beamwidth of the CCA may correspond to the widest beamwidth that can be created or configured using the antenna array.

For example, the antenna array may comprise a first antenna array providing a first polarization and a second antenna array providing a second polarization perpendicular to the first polarization. The beamformed reception may be implemented by apply a first sequence of precoding weights (e.g., receiver gain coefficients) to the first antenna array and a second sequence of precoding weights (e.g., receiver gain coefficients) to the second antenna array, wherein the first sequence and the second sequence are complementary sequences, i.e., pairs of sequences with the property that their out-of-phase aperiodic autocorrelation is relatively small or equal to zero. The complementary sequences may be binary complementary sequences, bipolar complementary sequences, and/or or Golay pairs.

A reception beamwidth of the beamformed reception of the CCA may be equal to or greater than a transmission beamwidth of the beamformed transmission from the UE.

The transmission beamwidth may also be referred to as transmit beamwidth. Alternatively or in addition, the reception beamwidth may also be referred to as a receive beamwidth (i.e., a sensing beamwidth).

An angular range of the beamformed reception of the CCA may cover a transmission beam of the beamformed transmission from the UE.

The transmission beam may also be referred to as transmit beam. Alternatively or in addition, the angular range of the beamformed reception may correspond to a receive beam (i.e., a sensing beam).

A beamformed reception filter may be used for the beamformed reception of the CCA and a beamformed transmission filter may be used for the beamformed transmission. The beamformed transmission filter may correspond to the beamformed reception filter. Alternatively or in addition, the beamforming weights for the beamformed transmission may also be used for the beamformed reception of the CCA. The beamforming weights to be used, e.g., according to the beam correspondence (i.e., the spatial relation), for the beamformed transmission may also be used for the beamformed reception of the CCA.

The beamformed reception filter may also be referred to as beamforming filter or spatial filter for the beamformed reception. The beamformed transmission filter may also be referred to as beamforming filter or spatial filter for the beamformed transmission. The filters may be collectively referred to as beamforming filters or spatial filters. The beamforming filter may also be referred to as a spatial filter, e.g., because beamforming may correspond to spatial filtering.

The beamformed reception filter may correspond to the beamformed transmission filter in that the same spatial filter is used for the beamformed reception of the CCA and the beamformed transmission. Alternatively or in addition, the spatial filter (or each of the spatial filters) may comprise precoding weights, e.g., one precoding weight for each antenna (e.g., each antenna element or each antenna port) of the antenna array.

The beamformed reception filter may correspond to the beamformed transmission filter in that the same or corresponding precoding weights are used for the beamformed reception of the CCA and the beamformed transmission. For example, the precoding weights used for the beamformed reception of the CCA may be complex-conjugated numbers of the precoding weights used for the beamformed transmission. The spatial filter (or each of the spatial filters) may also be referred to as a beamforming precoder (or briefly: precoder). The spatial filter for the beamformed reception may be applied downstream of the antenna array, i.e., as a spatial decoder, in contrast to the spatial filter for the beamformed transmission that may be applied upstream of the antenna array, i.e., as a spatial precoder.

The source channel or the source signal may be related to a channel or a signal transmitted in the beamformed transmission according to a configuration of a spatial relation between the channel or the signal transmitted in the beamformed transmission and the source channel or the source signal.

The beamforming weights may be determined by maximizing a received power (e.g., a reference signal received power, RSRP) and/or a signal to noise ratio (SNR) and/or a signal to interference and noise ratio (SINR) for the source channel or the source signal.

The channel or the signal transmitted in the beamformed transmission may also be referred to as a target channel or a target signal. Herein, the terms signal, channel, and resource may be used interchangeably and/or in combination (e.g., signal resource or source SRS resource).

The source channel or the source signal may be transmitted from the transmitting station (e.g., an UL transmission or a DL transmission). Alternatively or in addition, the source channel or the source signal may be received at the transmitting station (e.g., an UL reception or a DL reception).

The precoding weights may also be referred to as beamforming weights. The precoding weights may be applied to each antenna (e.g., each antenna element and/or each antenna port) of the antenna array. The precoding weights may be collectively referred to as beamforming vector or precoding vector or precoder.

The configuration of the spatial relation may be received from the network node, optionally in response to indicating a beam correspondence to the network node.

The method may further comprise a step of transmitting or receiving at least one configuration message that is indicative of the configuration of the spatial relation.

The configuration message may be transmitted from the radio device to the network node or may be received from the network node at the radio device.

The configuration message may be a downlink control information (DCI), e.g., wherein the beamformed transmission is based on a dynamic scheduling (e.g., by the network node). Alternatively or in addition, the configuration message may be radio resource control (RRC) signaling (i.e., a RRC configuration), e.g., wherein the beamformed transmission is based on a configured grant (CG) of Type-1.

Alternatively or in addition, the configuration message may be an activating DCI (e.g., an UL DCI, i.e., a DCI relating to an UL transmission), e.g., wherein the beamformed transmission is based on a configured grant (CG) of Type-2.

The at least one configuration message may be indicative of the configuration of different spatial relations for the different directions, optionally a different spatial relation for each of the different directions for which the CCA is performed.

Alternatively, the at least one configuration message may be indicative of the configuration of one spatial relation for the different directions, optionally one spatial relation for each of the different directions for which the CCA is performed.

The source signal of the spatial relation may be a Sounding Reference Signal (SRS).

Prior to the transmission, the UE determines the beamforming weights for the beamformed reception of the CCA based on a configured spatial relation to a previously transmitted SRS resource as indicated by downlink control information, DCI, in case of dynamic scheduling or by the radio resource control, RRC, configuration in the case of Configured Grant Type-1 or by an activating uplink, UL, DCI in case of Configured Grant Type-2.

The configured spatial relation may be the spatial relation between the source channel or the source signal and the channel or the signal transmitted in the beamformed transmission.

The same beamforming weights for transmitting an indicated SRS or the (e.g., the above) indicated SRS resource is used for the CCA and the subsequent transmission.

The transmission is transmitted using the same beamforming weights as an associated SRS resource.

For dynamically scheduled transmission, the associated SRS resource may be indicated by a SRS Resource Indicator (SRI) field in the UL DCI. Alternatively or in addition, for Configured Grant transmission, the activated associated SRS resource may be indicated by the RRC configuration for Configured Grant Type-1, or by the SRI field in the activating UL DCI for Configured Grant Type-2. Alternatively or in addition, the activated SRS resource may be further updated by the network node via a medium access control (MAC) control element (CE).

At least one or each of the beamformed reception of the CCA and the beamformed transmission may use beamforming weights determined for a previously transmitted SRS or determined based on a downlink reference signal or an SSB, optionally wherein the beamforming transmission transmits a SRS. Alternatively or in addition, at least one or each of the beamformed reception of the CCA and the beamformed transmission may use beamforming weights determined for a previously transmitted SRS or determined based on a downlink reference signal or an SSB. At least one or each of the beamformed reception of the CCA and the beamformed transmission uses beamforming weights determined for a previously transmitted SRS or determined based on a downlink reference signal or an SSB or a CSI-RS, optionally wherein the beamforming transmission comprises a PUCCH transmission.

The UE may be a UE without beam correspondence capability.

The UE may use an omni-directional or quasi-omni-directional beam for the beamformed reception of the CCA prior to the transmission or may use for the beamformed reception of the CCA prior to the transmission the widest beam or beamwidth that can be created or configured by the antenna panel. Optionally, the beamformed reception may cover at least the transmission direction of the subsequent UL transmission.

A reception beamwidth of the beamformed reception of the CCA may be greater than a transmission beamwidth of the beamformed transmission from the UE.

The transmission beamwidth may also be referred to as transmit beamwidth. Alternatively or in addition, the reception beamwidth may also be referred to as a receive beamwidth (i.e., a sensing beamwidth).

An angular range of the beamformed reception of the CCA may cover a transmission beam of the beamformed transmission from the UE.

The transmission beam may also be referred to as transmit beam. Alternatively or in addition, the angular range of the beamformed reception may correspond to a receive beam (i.e., a sensing beam).

The beamformed reception of the CCA at the UE may comprise at least one of energy detection, preamble detection, and virtual carrier sensing.

The UE may comprise multiple antenna panels, each of the multiple antenna panels comprising an antenna array, and wherein the same antenna panel is used for both the CCA and the beamformed transmission.

The CCA may comprise multiple beamformed receptions on the shared radio spectrum in different directions at the UE, optionally using at least one of: multiple beamformed reception filters directed in the different directions; and multiple antenna panels directed in the different directions.

The different directions may correspond to a peak or a global maximum or a main lobe of the gain of the respective beamformed reception filters and/or antenna panels.

The CCA may be performed in the different directions simultaneously.

Multiple CCA entities may perform the CCA independently in the different directions.

The multiple CCA entities may be executed separately and/or at the transmitting station.

The different directions may use different listen before talk (LBT) engines and/or LBT procedures, respectively.

The beamformed transmission may be performed selectively according to a listen before talk (LBT) procedure, the LBT procedure comprising a backoff counter that is decreased while the result of the CCA is indicative of the shared radio spectrum being unoccupied and the beamformed transmission being performed responsive to the backoff counter being equal to zero.

The LBT procedure may be performed independently for each of the different directions.

A backoff counter may be maintained independently for each of the different directions.

A backoff counter may be maintained independently for each of the different directions. Performing the LBT procedure independently for each of the different directions may comprise decreasing backoff counters associated with the respective directions while the result of the CCA performed in the respective directions is indicative of the shared radio spectrum being unoccupied. For example, as soon as any one of the backoff counters associated with the different directions is zero, the beamformed transmission may be performed in the respective direction (e.g., according to the selectivity of the step of selectively performing the beamformed transmission).

Each of the backoff counters associated with the different directions may be initialized by a random (e.g., natural) number. Each of the backoff counters may be initialized by the same random number or by independently generated random numbers.

Alternatively, the same LBT procedure may be performed for each of the different directions. Alternatively or in addition, the same backoff counter may be maintained for each of the different directions.

At least one of the CCA and the LBT procedure may be performed for the different directions at different time instances, optionally in consecutive durations or in separate durations.

The (e.g., consecutive) durations may be channel sensing duration of the LBT procedure.

Each of the consecutive durations for at least one of the CCA and the LBT procedure may comprise one or multiple sensing slots.

The one or more sensing slots may be sensing slots of the LBT procedure.

The time instances may be separated in a channel occupancy time (COT), e.g. at beam switches.

The COT may be a COT according to the LBT procedure. Alternatively or in addition, the beam switches may relate to switching the beamforming weights and/or the antenna panels, e.g., for the CCA being performed sequentially (e.g., consecutively) for the different directions.

At least one of the CCA and the LBT procedure may comprise one or more parameters, which are configured and/or maintained independently from each other for each of the different directions.

At least one of the CCA and the LBT procedure may comprises one or more parameters, which are configured and/or maintained for each of the different directions based on the one or more parameters for a primary direction out of the different directions.

The beamformed transmission may comprise transmitting data or control signaling according to a radio access technology (RAT) of the UE.

The RAT of the transmitting station may comprise 3GPP NR or 3GPP LTE.

The data may be transmitted in a physical downlink shared channel (PDSCH) or a physical uplink shared channel (PUSCH). Alternatively or in addition, the control signaling may be transmitted on a physical downlink control channel (PDCCH) or a physical uplink control channel (PUCCH).

The shared radio spectrum may be shared by multiple RATs comprising a RAT other than the RAT of the UE.

The other RAT may comprise Wi-Fi.

Herein, SSB may refer to a synchronization signal block or an SS/PBCH Block, i.e. a block comprising one or more synchronization signals (SS) and a physical broadcast channel (PBCH). Alternatively or in addition, CSI-RS may refer to a channel state information reference signal and/or DCI may refer to downlink control information.

The beamformed transmission may comprise transmitting at least one of a random access preamble (RAP), a physical random access channel (PRACH), a sounding reference signal (SRS), a physical uplink control channel (PUCCH), and a physical uplink shared channel (PUSCH).

The receiving station may comprise a network node, e.g. a network node of a radio access network (RAN).

The beamformed transmission may be an uplink (UL) transmission. Alternatively or in addition, the beamformed transmission may be a physical uplink shared channel (PUSCH) transmission.

At least one or each of the beamformed reception of the CCA and the beamformed transmission may use beamforming weights determined based on an SSB, optionally wherein the beamforming transmission comprises a PRACH transmission.

The beamformed transmission may comprise a PRACH transmission. The PRACH transmission may be related to the SSB, e.g., according to the beam correspondence (i.e., according to the configured spatial relation).

The SSB may be the source signal. Alternatively or in addition, the SSB may be received from the network node of the RAN serving the radio device.

The beamforming weights may be determined by maximizing a reference signal received power (RSRP) of the SSB at the transmitting station.

The transmitting station may be a radio device without beam correspondence capability and/or without indicating beam correspondence capability to the network node.

The method may further comprise or initiate the step of determining beamforming weights for at least one or each of the beamformed reception of the CCA and the beamformed transmission based on the latest reception from the receiving station, optionally by maximizing the SINR in the latest reception from the receiving station.

Optionally, the method may selectively act according to a UE with or without beam correspondence capability. By way of example, or according to another method aspect, a method of performing a beamformed transmission on shared radio spectrum at a transmitting station is provided.

When a UE is capable of beam correspondence, the method performed by the UE as the transmitting station comprises a step of indicating a capability of beam correspondence (and optionally determining beamforming weights for a beamformed reception of a CCA and the beamformed transmission based on a source channel or a source signal); a step of performing a or the CCA on the shared radio spectrum using an antenna array of the UE, wherein the CCA comprises a or the beamformed reception on the shared radio spectrum at the UE prior to the beamformed transmission; and a step of, depending on a result of the CCA, selectively performing the beamformed transmission on the shared radio spectrum using the antenna array from the UE to a receiving station.

When the UE is not capable of beam correspondence, the method performed by the UE as the transmitting station comprises a step of performing a CCA on the shared radio spectrum using an antenna array of the UE, wherein the CCA comprises a beamformed reception on the shared radio spectrum at the UE prior to the beamformed transmission; and a step of, depending on a result of the CCA, selectively performing the beamformed transmission on the shared radio spectrum using the antenna array from the UE to a receiving station. Optionally, the UE may use an omni-directional or quasi-omni-directional beam for the beamformed reception of the CCA prior to the transmission or may use for the beamformed reception of the CCA prior to the transmission the widest beam or beamwidth that can be created or configured by the antenna panel. Alternatively or in addition, the beamformed reception may cover at least the transmission direction of the subsequent UL transmission.

As to a second method aspect, a method of configuring a user equipment (UE) as a transmitting station for a beamformed transmission on shared radio spectrum is provided. The method performed by a network node as a receiving station comprises a step of transmitting at least one of a source signal for determining beamforming weights based on the source signal and a configuration message indicative of a configuration for determining the beamforming weights based on the source signal, wherein at least one of the source signal and the configuration message configures the UE to determine beamforming weights for a beamformed reception of a clear channel assessment (CCA) on the shared radio spectrum. Alternatively or in addition, receiving the beamformed transmission on the shared radio spectrum from the UE at a network node depending on a result of the CCA.

The method may further comprise a step of receiving an indication for a capability of beam correspondence.

The beamforming weights may also be used for the beamformed transmission.

The second method aspect may further comprise any feature and/or any step disclosed in the context of the first method aspect, or a feature and/or step corresponding thereto, e.g., a receiver counterpart to a transmitter feature or step.

In any aspect, the technique may be implemented by one or more methods for specifying channel sensing in millimeter wave frequency bands, preferably for 3GPP New Radio (NR) and/or unlicensed operation. Embodiments of the technique may be implemented for a fifth generation (5G) radio access technology (RAT), e.g., 3GPP New Radio (NR) and/or unlicensed operation (e.g., using the shared radio spectrum).

Alternatively or in addition, embodiments of the technique may perform the clear channel assessment (CCA) as channel sensing, e.g., for a listen before talk (LBT) procedure (also referred to as LBT operation).

The technique may be implemented based on, or in extension of, at least one of ETSI document EN 301893, version 2.1.1, on 5 GHz RLAN and on a harmonized standard covering the essential requirements of Article 3.2 of Directive 2014/53/EU; 3GPP document TS 37.213, version 16.5.0, on physical layer procedures for shared spectrum channel access; 3GPP document TS 38.212, version 16.5.0, on multiplexing and channel coding; 3GPP document TS 38.331, version 16.4.1, on radio resource control (RRC) protocol specification; 3GPP document of RAN1 Chairman's Notes on 3GPP TSG RAN WG1 Meeting #104-e; 3GPP document RP-193229 on a new work item description (WID) on extending current NR operation to 71 GHz; and ETSI document EN 302 567, version 2.1.1, on multiple-Gigabit/s radio equipment operating in the 60 GHz band, and on a harmonized standard covering the essential requirements of Article 3.2 of Directive 2014/53/EU.

Alternatively or in addition, the technique may be implemented based on, or in extension of the 3GPP document TS 38.213, version 16.5.0, on Radio Access Network as well as NR and Physical layer procedures for control, and/or the 3GPP document TS 38.214, version 16.5.0, on Radio Access Network as well as NR and Physical layer procedures for data.

In any aspect, any radio device may be a user equipment (UE), e.g., according to a 3GPP specification. Alternatively or in addition, any network node may be a base station of a radio access network (RAN), e.g., according to a 3GPP specification.

The radio device and the RAN or the network node may be wirelessly connected in an uplink (UL) and/or a downlink (DL) through a Uu interface. Alternatively or in addition, a sidelink (SL) may enable a direct radio communication between proximal radio devices, optionally using a PC5 interface. Services provided using the SL or the PC5 interface may be referred to as proximity services (ProSe). Any radio device (e.g., the remote radio device and/or the relay radio device and/or the further radio device) supporting a SL may be referred to as ProSe-enabled radio device.

The first method aspect may be performed by the transmitting station. Alternatively or in addition, the second method aspect may be performed by the receiving station. The radio device and the network node may embody the transmitting station and receiving station, respectively. Alternatively or in addition, the radio device and the network node may embody the receiving station and transmitting station, respectively.

The radio device and/or the network node form, or may be part of, a radio network, e.g., according to the Third Generation Partnership Project (3GPP) or according to the standard family IEEE 802.11 (Wi-Fi). The first method aspect, the first and/or second method aspect may be performed by one or more embodiments of the radio device and the network node (e.g., a base station).

The RAN may comprise one or more network nodes (e.g., base stations), e.g., performing the first and/or second method aspect. Alternatively or in addition, the radio network may be a vehicular, ad hoc and/or mesh network comprising two or more radio devices, e.g., acting as a remote radio device and/or a relay radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more base stations or network nodes. The radio device may be wirelessly connected or connectable (e.g., according to a radio resource control, RRC, state or active mode) with at least one base station of the RAN.

The base station or network node may encompass any station that is configured to provide radio access to any of the radio devices. The base stations may also be referred to as cell, transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B, 4G base station or eNodeB (eNB), a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to another aspect, a computer program product is provided. The computer program product comprises program code portions for performing any one of the steps of the first and/or second method aspect disclosed herein when the computer program product is executed by one or more computing devices. The computer program product may be stored on a computer-readable recording medium. The computer program product may also be provided for download, e.g., via the radio network, the RAN, the Internet and/or the host computer.

Alternatively, or in addition, the first and/or second method aspect may be encoded in a Field-Programmable Gate Array (FPGA) and/or an Application-Specific Integrated Circuit (ASIC), or the functionality may be provided for download by means of a hardware description language.

As to a first device aspect, a user equipment (UE) configured to perform the first method aspect is provided.

As to a further first device aspect, a UE is provided, the UE comprising memory operable to store instructions and processing circuitry operable to execute the instructions, such that the UE is operable to the first method aspect.

As to a second device aspect, a network node configured to perform the second method aspect is provided.

As to a further second device aspect, a network node is provided, the network node comprising memory operable to store instructions and processing circuitry operable to execute the instructions, such that the network node is operable to the second method aspect.

As to a still further aspect a communication system including a host computer is provided. The host computer comprises a processing circuitry configured to provide user data, e.g., included in the data of the selective transmission. The host computer further comprises a communication interface configured to forward the data to a cellular network (e.g., the RAN and/or the base station) for transmission to a UE. A processing circuitry of the cellular network is configured to execute any one of the steps of the second method aspects. Alternatively or in addition, the UE comprises a radio interface and processing circuitry, which is configured to execute any one of the steps of the first method aspects.

The communication system may further include the UE. Alternatively, or in addition, the cellular network may further include one or more base stations configured for radio communication with the UE and/or to provide a data link between the UE and the host computer using the first and/or second method aspects.

The processing circuitry of the host computer may be configured to execute a host application, thereby providing the data and/or any host computer functionality described herein. Alternatively, or in addition, the processing circuitry of the UE may be configured to execute a client application associated with the host application.

Any one of the devices, the UE, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for performing a beamformed transmission on shared radio spectrum;

FIG. 2 shows a schematic block diagram of an embodiment of a device for configuring a beamformed transmission on shared radio spectrum;

FIG. 3 shows a flowchart for a method of performing a beamformed transmission on shared radio spectrum, which method may be implementable by the device of FIG. 1;

FIG. 4 shows a flowchart for a method of configuring a beamformed transmission on shared radio spectrum, which method may be implementable by the device of FIG. 2;

FIG. 5 shows a schematic network environment, wherein a radio device acts as a transmitting station, which may embody the device of FIG. 1, and a network node acts as a receiving station, which may embody the device of FIG. 2;

FIG. 6 shows a schematic network environment, wherein a network node acts as a transmitting station, which may embody the device of FIG. 1, and a radio device acts as a receiving station, which may embody the device of FIG. 2;

FIG. 7 shows a schematic block diagram of a transmitting station embodying the device of FIG. 1;

FIG. 8 shows a schematic block diagram of a receiving station embodying the device of FIG. 2;

FIG. 9 schematically illustrates an example telecommunication network connected via an intermediate network to a host computer;

FIG. 10 shows a generalized block diagram of a host computer communicating via a base station or radio device functioning as a gateway with a user equipment over a partially wireless connection; and

FIGS. 11 and 12 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

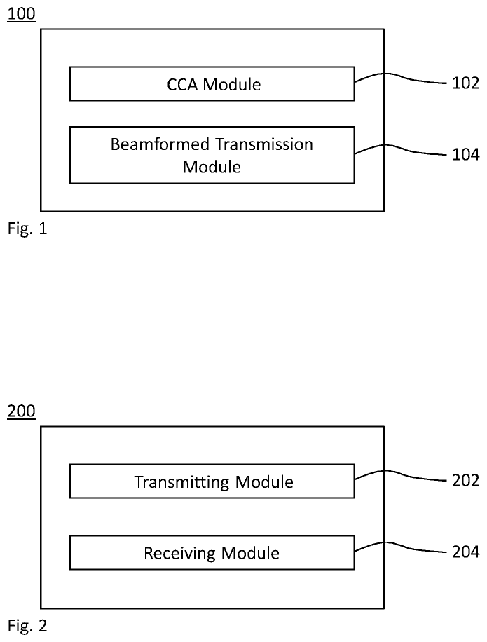

FIG. 1 schematically illustrates a block diagram of an embodiment of a device for performing a beamformed transmission on shared radio spectrum. The device is generically referred to by reference sign 100.

The device 100 comprises a CCA module 102 performing the step 302 of the first method aspect and a beamformed transmission module 104 performing the step 304 of the first method aspect.

Any of the modules of the device 100 may be implemented by units configured to provide the corresponding functionality.

The device 100 may also be referred to as, or may be embodied by, the transmitting station (or briefly: transmitter). The transmitting station 100 and the receiving station may be in direct radio communication, e.g., at least for the beamformed transmission from the transmitting station 100 to the receiving station. The receiving station may be embodied by the device 200.

FIG. 2 schematically illustrates a block diagram of an embodiment of a device for configuring a beamformed transmission on shared radio spectrum. The device is generically referred to by reference sign 200.

The device 200 comprises a transmitting module 202 performing the step 402 of the second method aspect and a receiving module 204 performing the step 404 of the second method aspect.

Any of the modules of the device 100 may be implemented by units configured to provide the corresponding functionality.

The device 200 may also be referred to as, or may be embodied by, the receiving station (or briefly: receiver). The transmitting station and the receiving station 200 may be in direct radio communication, e.g., at least for the multi-layer reception from the transmitting station to the receiving station 200. The transmitting station may be embodied by the device 100.

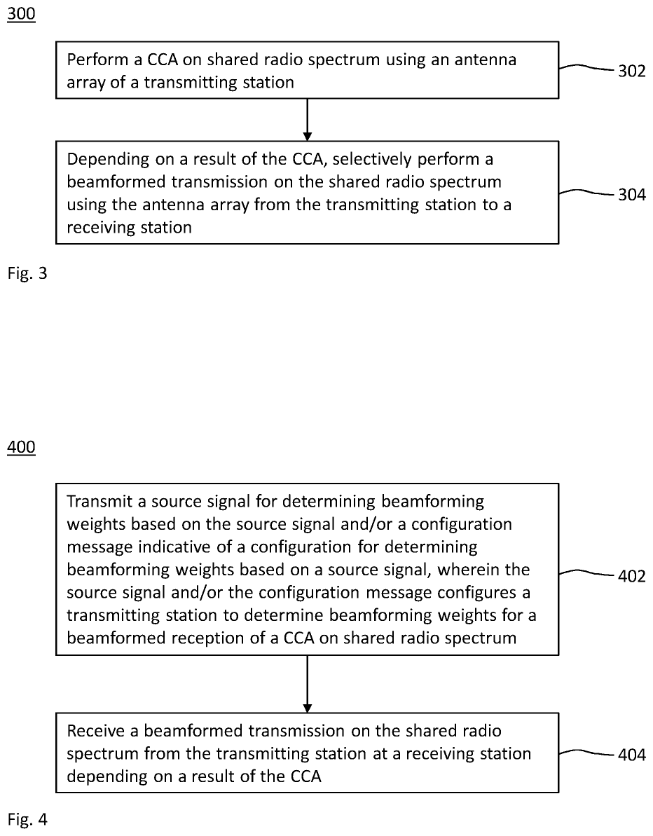

FIG. 3 shows an example flowchart for a method 300 of the first method aspect.

The method 300 may be performed by the device 100. For example, the modules 102 and 104 may perform the steps 302 and 304, respectively.

FIG. 4 shows an example flowchart for a method 400 of the second method aspect.

The method 400 may be performed by the device 200. For example, the modules 202 and 204 may perform the steps 402 and 404, respectively.

In any aspect, the technique may be applied to uplink (UL), downlink (DL) or direct communications between radio devices, e.g., device-to-device (D2D) communications or sidelink (SL) communications.

Each of the transmitting station 100 and receiving station 200 may be a radio device or a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to reference signal received power (RSRP) or a signal-to-noise ratio (SNR), a corresponding step, feature or effect is also disclosed for a signal-to-interference-and-noise ratio (SINR).

Any embodiment in any aspect of the technique may be implemented for NR in Unlicensed Spectrum (NR-U).

Allowing unlicensed networks, i.e., networks that operate in shared spectrum (or unlicensed spectrum) to effectively use the available spectrum is an attractive approach to increase system capacity. Although unlicensed spectrum does not match the qualities of the licensed regime, solutions that allow an efficient use of it as a complement to licensed deployments have the potential to bring great value to the 3GPP operators, and, ultimately, to the 3GPP industry as a whole. This type of solutions would enable operators and vendors to leverage the existing or planned investments in LTE/NR hardware in the radio and core network.

For the transmitting station 100 to be allowed to transmit in unlicensed spectrum in lower frequency band, it typically needs to perform a clear channel assessment (CCA), e.g., a Listen Before Talk (LBT) procedure. This procedure (i.e., the CCA) may include sensing if the wireless medium is unoccupied (i.e., idle). Sensing the medium to be idle can be done in different ways, e.g. using at least one of energy detection; preamble detection; and virtual carrier sensing. The former may imply that the node (e.g., the network node) listens to the channel and measures the energy of the interference (plus noise) for a number of time intervals. If the energy is less than a certain threshold (e.g., an Energy Detection, ED, threshold), it declares that the medium is idle. Otherwise, it declares that the medium is busy (i.e., occupied).

After sensing the medium (i.e., the shared radio spectrum) to be idle, the node is typically allowed to transmit for a certain duration, sometimes referred to as transmission opportunity (TXOP) or Channel Occupancy Time (COT). In some jurisdictions, the maximum duration of a COT depends the type of CCA that has been performed. Typical ranges are 1 ms to 10 ms. This limit is denoted Maximum Channel Occupancy Time (MCOT). During a COT a gNB is allowed to share its access to the wireless medium with uplink transmissions from UEs.

Sometimes, this is referred to as shared COT. A major goal of introducing the shared COT concept is to minimize the need of UEs to perform a long LBT prior to transmissions in the uplink. In some jurisdictions, a scheduled UE is permitted performing a short LBT immediately following the downlink transmission.

LBT procedures for different devices could be different depending on the frequency band, regions, services.

Any embodiment in any aspect may use LBT in the sub-7 GHz band.

NR-U networks (e.g., according to 3GPP Release 16) in the sub-7 GHz band follow an LBT procedure, which is mainly based on the ETSI harmonized standard, e.g., according to ETSI document EN 301893, version 2.1.1, on 5 GHz RLAN and on a harmonized standard covering the essential requirements of Article 3.2 of Directive 2014/53/EU. The ETSI harmonized standard may include at least one of the following parameters and/or properties.
LBT modes: there are 2 LBT modes, applied to 2 different types of equipment's/services
   Load-based equipment (LBE): target to operate on environment with interference from other networks, following a specific LBT procedure for LBE (e.g., LBE LBT mode, e.g., a channel access mode that is dynamic according to the 3GPP document TS 37.213, version 16.5.0, on physical layer procedures for shared spectrum channel access).
   Frame-based equipment (FBE): target to operate on environment with no interference or controlled interference from other networks, following a specific LBT procedure for FBE (i.e., FBE LBT mode, e.g., an channel access mode that is semi static or “semiStatic” according to the 3GPP document TS 37.213, version 16.5.0, on physical layer procedures for shared spectrum channel access).
   In NR rel-16, the LBT mode is configured per cell using the RRC parameter channelAccessMode-r16

The RRC parameter channelAccessMode-r16 may be defined according to the following Abstract Syntax Notation One (ASN.1):

| | |
|---|---|
| channelAccessMode-r16 | CHOICE { |
| dynamic | NULL, |
| semiStatic | SemiStaticChannelAccessConfig- |
| r16 | |
| } | |

ED threshold: ED threshold in rel-16 NR is defined as energy threshold for measurement per 20 MHz. ED threshold for LBT in rel-16 NR is configured/signaled to the UEs via RRC parameters maxEnergyDetectionThreshold-r16 and optionally energyDetectionThresholdOffset-r16

The RRC parameters maxEnergyDetectionThreshold-r16 and/or energyDetectionThresholdOffset-r16 may be defined according to the following Abstract Syntax Notation One (ASN.1):

| | |
|---|---|
| ChannelAccessConfig-r16 ::= | SEQUENCE { |
| energyDetectionConfig-r16 | CHOICE { |
| maxEnergyDetectionThreshold-r16 | INTEGER (−85..−52), |
| energyDetectionThresholdOffset-r16 | INTEGER (−13..20) |
| } | |
| ul-toDL-COT-SharingED-Threshold-r16 | INTEGER (−85..−52) |
| absenceOfAnyOtherTechnology-r16 | ENUMERATED {true} |
| } | |

LBT parameters
   In Rel-16 NR, different LBT parameters were defined based on ETSI document EN 301893, version 2.1.1, on 5 GHz RLAN and on a harmonized standard covering the essential requirements of Article 3.2 of Directive 2014/53/EU, including LBT categories, switching gap, channel access priority class, etc.
   In Rel-16 NR, the LBT parameters for UL transmission are generally signaled to the UEs via DL DCI (e.g., for PUCCH) or UL DCI (e.g., for PUSCH).
   Depending on the LBT modes (i.e., LBE LBT or FBE LBT) and DCI types, different combinations of the LBT parameters could be configured and signaled. For instance, for LBE LBT and UL DCI 0_1, the following combinations of LBT parameters could be configured according to 3GPP document TS 38.212, version 16.5.0, on multiplexing and channel coding.

Allowed entries for DCI format 0_1, which may be configured by higher layer parameter ul-AccessConfigListDCI-0-1, may be defined according to Table 7.3.1.1.2-35 of the 3GPP document TS 38.212, version 16.5.0 and/or according to below table.

| | | The CP extension | Channel |
|---|---|---|---|
| | | T_“ext” index, | Access |
| | | e.g. as defined in | Priority |
| Entry | | clause 5.3.1 of 3GPP | Class |
| index | Channel Access Type | document TS 38.211 | (CAPC) |
| 0 | Type2C-ULChannelAccess (e.g. | 0 | 1 |
| | as defined in clause 4.2.1.2.3 of | | |
| | 3GPP document 37.213) | | |
| 1 | Type2C-ULChannelAccess (e.g. | 0 | 2 |
| | as defined in clause 4.2.1.2.3 of | | |
| | 3GPP document 37.213) | | |
| 2 | Type2C-ULChannelAccess (e.g. | 0 | 3 |
| | as defined in clause 4.2.1.2.3 of | | |
| | 3GPP document 37.213) | | |
| 3 | Type2C-ULChannelAccess (e.g. | 0 | 4 |
| | as defined in clause 4.2.1.2.3 of | | |
| | 3GPP document 37.213) | | |
| 4 | Type2C-ULChannelAccess (e.g. | 2 | 1 |
| | as defined in clause 4.2.1.2.3 of | | |
| | 3GPP document 37.213) | | |
| 5 | Type2C-ULChannelAccess (e.g. | 2 | 2 |
| | as defined in clause 4.2.1.2.3 of | | |
| | 3GPP document 37.213) | | |
| 6 | Type2C-ULChannelAccess (e.g. | 2 | 3 |
| | as defined in clause 4.2.1.2.3 of | | |
| | 3GPP document 37.213) | | |
| 7 | Type2C-ULChannelAccess (e.g. | 2 | 4 |
| | as defined in clause 4.2.1.2.3 of | | |
| | 3GPP document 37.213) | | |
| 8 | Type2B-ULChannelAccess (e.g. | 0 | 1 |
| | as defined in clause 4.2.1.2.3 of | | |
| | 3GPP document 37.213) | | |
| 9 | Type2B-ULChannelAccess (e.g. | 0 | 2 |
| | as defined in clause 4.2.1.2.3 of | | |
| | 3GPP document 37.213) | | |
| 10 | Type2B-ULChannelAccess (e.g. | 0 | 3 |
| | as defined in clause 4.2.1.2.3 of | | |
| | 3GPP document 37.213) | | |
| 11 | Type2B-ULChannelAccess (e.g. | 0 | 4 |
| | as defined in clause 4.2.1.2.3 of | | |
| | 3GPP document 37.213) | | |
| 12 | Type2B-ULChannelAccess (e.g. | 2 | 1 |
| | as defined in clause 4.2.1.2.3 of | | |
| | 3GPP document 37.213) | | |
| 13 | Type2B-ULChannelAccess (e.g. | 2 | 2 |
| | as defined in clause 4.2.1.2.3 of | | |
| | 3GPP document 37.213) | | |
| 14 | Type2B-ULChannelAccess (e.g. | 2 | 3 |
| | as defined in clause 4.2.1.2.3 of | | |
| | 3GPP document 37.213) | | |
| 15 | Type2B-ULChannelAccess (e.g. | 2 | 4 |
| | as defined in clause 4.2.1.2.3 of | | |
| | 3GPP document 37.213) | | |
| 16 | Type2A-ULChannelAccess (e.g. | 0 | 1 |
| | as defined in clause 4.2.1.2.1 in | | |
| | 3GPP document TS 37.213) | | |
| 17 | Type2A-ULChannelAccess (e.g. | 0 | 2 |
| | as defined in clause 4.2.1.2.1 in | | |
| | 3GPP document TS 37.213) | | |
| 18 | Type2A-ULChannelAccess (e.g. | 0 | 3 |
| | as defined in clause 4.2.1.2.1 in | | |
| | 3GPP document TS 37.213) | | |
| 19 | Type2A-ULChannelAccess (e.g. | 0 | 4 |
| | as defined in clause 4.2.1.2.1 in | | |
| | 3GPP document TS 37.213) | | |
| 20 | Type2A-ULChannelAccess (e.g. | 1 | 1 |
| | as defined in clause 4.2.1.2.1 in | | |
| | 3GPP document TS 37.213) | | |
| 21 | Type2A-ULChannelAccess (e.g. | 1 | 2 |
| | as defined in clause 4.2.1.2.1 in | | |
| | 3GPP document TS 37.213) | | |
| 22 | Type2A-ULChannelAccess (e.g. | 1 | 3 |
| | as defined in clause 4.2.1.2.1 in | | |
| | 3GPP document TS 37.213) | | |
| 23 | Type2A-ULChannelAccess (e.g. | 1 | 4 |
| | as defined in clause 4.2.1.2.1 in | | |
| | 3GPP document TS 37.213) | | |
| 24 | Type2A-ULChannelAccess (e.g. | 3 | 1 |
| | as defined in clause 4.2.1.2.1 in | | |
| | 3GPP document TS 37.213) | | |
| 25 | Type2A-ULChannelAccess (e.g. | 3 | 2 |
| | as defined in clause 4.2.1.2.1 in | | |
| | 3GPP document TS 37.213) | | |
| 26 | Type2A-ULChannelAccess (e.g. | 3 | 3 |
| | as defined in clause 4.2.1.2.1 in | | |
| | 3GPP document TS 37.213) | | |
| 27 | Type2A-ULChannelAccess (e.g. | 3 | 4 |
| | as defined in clause 4.2.1.2.1 in | | |
| | 3GPP document TS 37.213) | | |
| 28 | Type1-ULChannelAccess (e.g. | 0 | 1 |
| | as defined in clause 4.2.1.1 of | | |
| | 3GPP document TS 37.213) | | |
| 29 | Type1-ULChannelAccess (e.g. | 0 | 2 |
| | as defined in clause 4.2.1.1 of | | |
| | 3GPP document TS 37.213) | | |
| 30 | Type1-ULChannelAccess (e.g. | 0 | 3 |
| | as defined in clause 4.2.1.1 of | | |
| | 3GPP document TS 37.213) | | |
| 31 | Type1-ULChannelAccess (e.g. | 0 | 4 |
| | as defined in clause 4.2.1.1 of | | |
| | 3GPP document TS 37.213) | | |
| 32 | Type1-ULChannelAccess (e.g. | 1 | 1 |
| | as defined in clause 4.2.1.1 of | | |
| | 3GPP document TS 37.213) | | |
| 33 | Type1-ULChannelAccess (e.g. | 1 | 2 |
| | as defined in clause 4.2.1.1 of | | |
| | 3GPP document TS 37.213) | | |
| 34 | Type1-ULChannelAccess (e.g. | 1 | 3 |
| | as defined in clause 4.2.1.1 of | | |
| | 3GPP document TS 37.213) | | |
| 35 | Type1-ULChannelAccess (e.g. | 1 | 4 |
| | as defined in clause 4.2.1.1 of | | |
| | 3GPP document TS 37.213) | | |
| 36 | Type1-ULChannelAccess (e.g. | 2 | 1 |
| | as defined in clause 4.2.1.1 of | | |
| | 3GPP document TS 37.213) | | |
| 37 | Type1-ULChannelAccess (e.g. | 2 | 2 |
| | as defined in clause 4.2.1.1 of | | |
| | 3GPP document TS 37.213) | | |
| 38 | Type1-ULChannelAccess (e.g. | 2 | 3 |
| | as defined in clause 4.2.1.1 of | | |
| | 3GPP document TS 37.213) | | |
| 39 | Type1-ULChannelAccess (e.g. | 2 | 4 |
| | as defined in clause 4.2.1.1 of | | |
| | 3GPP document TS 37.213) | | |
| 40 | Type1-ULChannelAccess (e.g. | 3 | 1 |
| | as defined in clause 4.2.1.1 of | | |
| | 3GPP document TS 37.213) | | |
| 41 | Type1-ULChannelAccess (e.g. | 3 | 2 |
| | as defined in clause 4.2.1.1 of | | |
| | 3GPP document TS 37.213) | | |
| 42 | Type1-ULChannelAccess (e.g. | 3 | 3 |
| | as defined in clause 4.2.1.1 of | | |
| | 3GPP document TS 37.213) | | |
| 43 | Type1-ULChannelAccess (e.g. | 3 | 4 |
| | as defined in clause 4.2.1.1 of | | |
| | 3GPP document TS 37.213) | | |

Alternatively or in addition, any embodiment in any aspect of the technique may use LBT in a high frequency spectrum (e.g., greater than 50 GHz and/or in the millimeter wave frequency bands).

The technique may be implemented for 3GPP NR release 17 and/or in fulfilment of a work item (WI) approved in 3GPP to study and extend NR support in the frequency range of 52.6 GHz to 71 GHz, e.g., according to 3GPP document RP-193229 on a new work item description (WID). One of the main objectives of this WI is the study of channel access mechanism, considering potential interference to/from other nodes, assuming beam based operation, in order to comply with the regulatory requirements applicable to unlicensed spectrum for frequencies between 52.6 GHz and 71 GHz.

Due to the directional transmissions and large propagation, co-existence interference is negligible in the frequency range of 52.6 GHz to 71 GHz. Therefore, the benefit of LBT in this frequency band is limited. In most scenarios, LBT even degrades the system performance due to LBT overhead compared to no LBT (i.e., devices transmitting without channel sensing). It is agreed in RAN1 that both LBT and no LBT modes are supported for NR-U release 17.

When operating with LBT mode in the frequency range of 52.6 GHz to 71 GHz, the LBT procedure is agreed to be based on ETSI document EN 302 567, version 2.1.1 (on multiple-Gigabit/s radio equipment operating in the 60 GHz band, and on a harmonized standard covering the essential requirements of Article 3.2 of Directive 2014/53/EU), which is different and in general simpler than the LBT procedure in sub-7 GHz band. For instance, in ETSI HS, there is only one LBT category (instead of 4 as in sub-7 GHz), there is no CAPC defined or contention window updated, the ED threshold is not based on unit of 20 MHz BW.

The transmitting station 100 may apply a Quasi-Co-Located (QCL) mechanism (also referred to as QCL assumption), e.g., for DL transmission 304.

In the downlink, physical channel or signals that are transmitted from different antenna ports from the same base station can experience the same large-scale channel properties, in terms of Doppler shift, Doppler spread, average delay and delay spread. The gNB can signal to the UE the correlation between the large-scale channel properties of two downlink physical channels or signals, so that the UE can estimate the channel properties from the source RS when receiving the target DL channel or signal. This is achieved by introducing the QCL mechanism.

The antenna ports that share a certain set of large-scale channel properties are said to be quasi-co-located of certain type. Four different QCL types between a source RS and a target DL channel or signal are defined in the 3GPP specification, as listed below.
Type A: {Doppler shift, Doppler spread, average delay, delay spread}
Type B: {Doppler shift, Doppler spread}
Type C: {average delay, Doppler shift}
Type D: {Spatial Rx parameter}

The network can then signal to the UE that two antenna ports are QCL. If the UE knows that two antenna ports are QCL with respect to a certain parameter, the UE can estimate that parameter based on one of the antenna ports and use that estimate when receiving the other antenna port.

In addition, QCL type D was introduced to facilitate beam management with analog beamforming and is known as spatial QCL. If a DL channel is indicated to be QCL with respective to Type D with a DL RS, the UE can use the same spatial filter (beam) used to receive the source RS to receive the target channel.

The transmitting station 100 may use a spatial relation (e.g., for UL transmission) and/or the receiving station may configure the spatial relation.

3GPP introduced for NR in release 15 the concept of spatial relation to facilitate network control of the UE transmission directions. Spatial relation is used to inform the UE how to tune its transmitter antenna array for transmitting an UL channel/signal with reference to a spatial relation source signal. Loosely speaking, this tells the UE it should beam-form the UL channel/signal in the same way as it received/transmitted the specified spatial relation source signal. The spatial relation source signal may be a synchronization signal (SS) and physical broadcast channel (PBCH) block (also referred to as SS/PBCH block or SSB), a channel state information (CSI) reference signal (CSI-RS), or a Sounding Reference Signal (SRS).

The beamformed transmission 304 may be a PRACH transmission for a RACH procedure. Before starting the RACH procedure, the UE measures on a set of SS/PBCH blocks and chooses a suitable one. Then the UE transmits on the PRACH resources associated with the selected SS/PBCH block. For UE with beam corresponding capability, it can transmit the PRACH with the spatial filter that gives the best RSRP when receiving the selected SS/PBCH block. For UE without beam correspondence capability, it might need to try out different beams when transmitting the PRACH until the PRACH transmission is acknowledged by the network with a Random Access Response (RAR) message.

Alternatively or in addition, the beamformed transmission 304 may transmit a SRS. The UE 100 can be configured with one or multiple SRS resource sets, which contains one or multiple SRS resources. Each SRS resource may be configured with a spatial relation (SRS-SpatialRelationInfo) to a DL RS (e.g., SSB or CSI-RS) or another SRS resource, which instructs the UE which spatial filter to use for transmission of that SRS resource. For an SRS resource that is not configured with a spatial relation, the UE may transmit that SRS resource using any spatial domain filter.

Alternatively or in addition, the beamformed transmission 304 may be a PUCCH transmission. The spatial relation for PUCCH transmission is configured by the parameter PUCCH-SpatialRelationInfo. For each PUCCH resource, the parameter PUCCH-SpatialRelationInfo provides the spatial relation to source signal. After configuring the UE with a list of spatial relations, the gNB activates one of them using a MAC control element (MAC CE). The update will typically come as a response to that the UE has reported a stronger received power for another reference signal (e.g., SSB or CSI-RS) or that the gNB has indicated a preferred reference signal (e.g., SRS) other than the one the current spatial relation is associated with. Thus, as the UE moves around in the cell, UE provides CSI report to the gNB, based on which the gNB will update the currently active spatial relation (e.g., for PUCCH).

Alternatively or in addition, the beamformed transmission 304 may be a PUSCH transmission. Both codebook-based and non-codebook-based transmissions (e.g., multiple-input multiple-output, MIMO, transmissions) on the PUSCH are associated with an indicated SRS resource. That is to say, the PUSCH should be transmitted using the same spatial filter (beam) as the associated SRS resource.

For dynamically scheduled PUSCH transmission, the associated SRS resource is indicated by the SRI (SRS Resource Indicator) field in the UL DCI. For Configured Grant PUSCH transmission, the activated associated SRS resource is indicated by the RRC configuration for Configured Grant Type-1, or by the SRI field in the activating UL DCI for Configured Grant Type-2. The activated SRS resource can be further updated by the gNB via a MAC-CE.

Any embodiment in any aspect of the technique may use beam correspondence (also referred to as channel reciprocity).

Beam correspondence is a UE capability that the UE 100 indicates to the gNB 200 via UE capability reporting. For a UE that indicates beam correspondence, the gNB can expect that the UE is able to derive its UL transmission beam from the DL reception beam used to receive a certain reference signal. Therefore, the gNB can configure UE with spatial relation for a PUCCH or SRS to a DL RS such as SSB or CSI-RS. For a UE without beam correspondence capability, the gNB may have to signal an UL RS (SRS) used for UL beam management as a spatial relation for the UL transmission.

Embodiments of the technique can provide details on channel sensing yet to be specified considering the physical characteristics of the radio channel and usage of large antenna arrays in this frequency band.

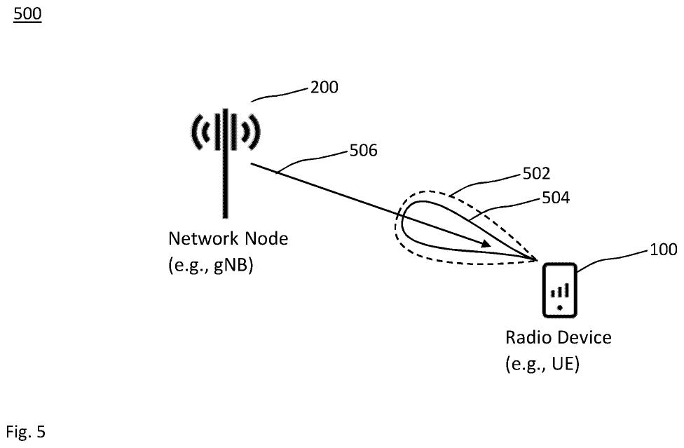

FIG. 5 shows a schematic network environment 500 comprising a radio device functioning as a transmitting station 100 and a network node functioning as a receiving station 200.

The beamformed reception 502 (e.g., a corresponding sensing beam or a reception beamwidth or a corresponding spatial filter or a corresponding angular range) for the CCA 302 is schematically illustrated in relation to a transmission beam 504 (e.g., a corresponding transmission beamwidth or a corresponding spatial filter or a corresponding angular range) of the beamformed transmission 304.

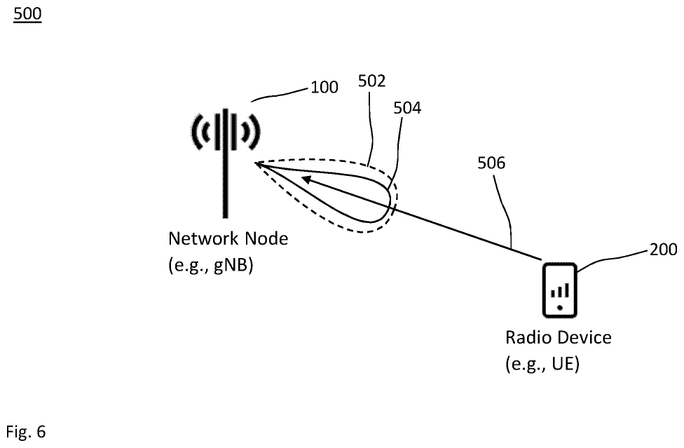

FIG. 6 shows a schematic network environment 500 comprising a radio device functioning as a receiving station 200 and a network node functioning as a transmitting station 200.

In any aspect, embodiments can perform channel sensing for DL and/or UL transmission for NR operation, e.g., in unlicensed bands and/or above 52.6 GHz.

The antenna array may be a large antenna arrays (e.g., comprising more than 50 or more than 100 antennas) used in the gNB and/or the UE.

More specifically, this technique may specify (e.g., configure) and/or use the spatial relationship between beams for channel sensing 302 and for subsequent DL or UL transmission 304.

In a first embodiment, the beamforming transmission 304 is a downlink (DL) transmission. The CCA 302 (i.e., the channel sensing) may be performed for the DL transmission and/or by a network node of a RAN as the transmitting station. A radio device may function as the receiving station 200.

Herein, a gNB is described as an example of the network node, for concreteness and not limitation of the disclosure.

When LBT is mandated by regional regulation and/or activated in the network (e.g., the RAN), gNB performs channel sensing (i.e., the CCA 302) immediately before DL transmission 304 starts, whereby the DL transmission includes at least one of a broadcast signal (also referred to as a broadcast channel) and a multicast signal (also referred to as a multicast channel), such as SSB, CSI-RS, PDCCH, PDSCH. Alternatively or in addition, the DL transmission includes a unicast signal (also referred to as unicast channel) such as CSI-RS, PDCCH and PDSCH.

The below variants and options may be combinable.

According to a first variant of the first embodiment, the gNB as the transmitting station 100 senses the radio channel (i.e., the shared radio spectrum) using the beamformed reception during the CCA 302. The beamformed reception may correspond to the quasi-omni-directional beam (i.e., as a sensing beam) that at least covers the transmission direction and/or transmission beamwidth of the subsequent DL transmission 304.

For a gNB 100 equipped with multiple antenna panels, wherein boresights of the antenna panels point at different directions, the gNB 100 performs channel sensing for the CCA 302 using the same antenna panel as the one to be used in the subsequent DL transmission 304. To ensure the channel sensing range (i.e., the angular range of the beamformed reception of the CCA 302) covers the direction of the subsequent DL transmission 304, the gNB 100 can perform channel sensing using the reception beamwidth, e.g., the quasi-omni-directional beam (as the sensing beam) from the antenna panel, i.e., the widest beam that can be created by the antenna panel.

According to a second variant of the first embodiment, the gNB 100 senses the radio channel in the step 302 using the same spatial filter (i.e., beamforming filter or beamforming precoder) on the same antenna panel as for the subsequent DL transmission 304.

According to the third variant of the first embodiment, the gNB 100 senses the radio channel (i.e., the shared radio spectrum) in multiple directions (also referred to as beams), e.g., using multiple antenna panels and/or multiple beamforming precoders, optionally based on one or multiple of the following options:

According to a first sub-embodiment, the gNB 100 senses the channel instantaneously in different directions using multiple antenna panels and/or multiple beamforming precoders in the CCA 302. In the first sub-embodiment, a first option comprises channel sensing in different directions using the same LBT engine and/or the same LBT procedure. A second option comprises channel sensing in different directions using different LBT engines and/or different LBT procedures.

According to a second sub-embodiment, the gNB 100 senses the channel (i.e., the shared radio spectrum) in different directions using different antenna panels and/or different beamforming precoders in (or at) different time instances.

In a first option for the second sub-embodiment, the time instances are consecutive channel sensing durations of the LBT procedure (e.g., according to the idle slot duration). For example, a single sensing duration can consist of one or multiple sensing slots. In a second option, the time instances are consecutive short channel sensing durations within a single sensing slot in the LBT procedure. In a third option, the time instances are separated at beam switches in a COT.

According to a fourth variant of the first embodiment, when the gNB 100 senses the radio channel (i.e., the shared radio spectrum) in multiple directions, LBT parameters of the LBT procedure for each of the directions may be one or more of the following options. In a first option, the LBT parameters for each direction is independent of the LBT parameters for the other directions. In a second option, the LBT parameters for each direction are dependent of the LBT parameters for one or each of the other directions. E.g., one direction may be selected as a primary direction (e.g., the direction which is sensed primarily). The LBT parameters in the other directions may be dependent on the outcome and/or the type of the sensing in the primary direction.

In a second embodiment, which may be combinable with the first embodiment, the beamforming transmission 304 is an uplink (UL) transmission. The CCA 302 (i.e., the channel sensing) may be performed for the UL transmission and/or by a radio device as the transmitting station 100. For example, the network node of a RAN may provide radio access to the radio device 100 and/or may function as the receiving station 200.

Herein, a user equipment (UE) is described as an example of the radio device 100, e.g., for concreteness and not limitation of the disclosure.

When LBT is mandated (e.g., required) by regional regulation and/or activated in the network (e.g., the RAN), the UE 100 performs channel sensing (i.e., the CCA 302) immediately before UL transmission starts. The UL transmission may include the beamformed transmission 304 of at least one of random access preamble (or a transmission of a physical random access channel, PRACH), a sounding reference signal (SRS), a transmission of a physical uplink control channel (PUCCH), and a transmission of a physical uplink shared channel (PUSCH).

According to an embodiment 2a, which may comprise at least one or each feature of the second embodiment, channel sensing 302 for a UL transmission 304 is performed by a radio device (e.g., UE) as the transmitting station 100 with beam correspondence capability.

According to a first variant of the embodiment 2a, the UE 100 senses the radio channel for the CCA 302 (e.g., using the omni-directional or quasi-omni-directional beam) that at least covers the transmission direction of the subsequent UL transmission 304. Optionally, for a UE 100 equipped with multiple antenna panels, wherein the boresights of the antenna panels point at different directions, the UE 100 may perform the channel sensing 302 using the same antenna panel as the one to be used in the subsequent UL transmission. To ensure the channel sensing range cover the direction of the subsequent UL transmission, the UE 100 may perform channel sensing using the quasi-omni-directional beam from the antenna panel, e.g., the widest beam that can be created by the antenna panel.

According to a second variant of the embodiment 2a, the UE 100 senses the radio channel during the CCA 302 using the same spatial filter (i.e., beamforming precoder) on the same antenna panel as for the subsequent UL transmission 304. The UE 100 determines a beamforming precoding vector (e.g., the beamforming weights) for the UL transmission 304 based on a configuration of a spatial relation for the UL channel or signal transmitted in the beamformed transmission 304. Therefore, the spatial relation configured (e.g., specified) for the UL transmission 304 to a DL or UL source is also used in the channel sensing.

The UE 100 may indicate (e.g., by transmitting a control signaling to the network node 200) a capability of beam correspondence.

For example, prior to the PRACH transmission 304 at a PRACH occasion, the UE 100 determines the beamforming precoder (i.e., the beamforming weights) for channel sensing (i.e., for the CCA 302) based on the spatial relation to the SSB associated with the PRACH occasion. The spatial filter that achieves the best SSB RSRP, which should also be the optimal spatial filter for the PRACH transmission, should be used for channel sensing prior to the PRACH transmission.

Alternatively or in addition, prior to a SRS transmission, the UE determines the beamforming precoder (i.e., the beamforming weights) for channel sensing (i.e., for the beamformed reception of the CCA 302) based on the configured spatial relation to another previously transmitted SRS resource or to a DL RS such as SSB or CSI-RS as specified in the SRS configuration. If the SRS to be transmitted is not configured with a spatial relation, the UE is allowed to transmit the SRS resource using any spatial filter. In the case the UE should ensure the same spatial filter is used for both channel sensing and the subsequent SRS transmission.

Alternatively or in addition, prior to a PUSCH transmission, the UE determines the beamforming precoder (i.e., the precoding weights) for channel sensing (i.e., for the beamformed reception of the CCA 302) based on the configured spatial relation to a previously transmitted SRS resource as indicated by the DCI in case of dynamic scheduling or by the RRC configuration in the case of Configured Grant Type-1 or by the activating UL DCI in case of Configured Grant Type-2. The same spatial filter (i.e., the same beamforming precoder or precoding weights) for transmitting the indicated SRS resource should be used for the channel sensing 302 and the subsequent PUSCH transmission 304.

Alternatively or in addition, prior to the PUCCH transmission, the UE determines the beamforming precoder (i.e., the precoding weights) for channel sensing (i.e., for the beamformed reception of the CCA 302) based on the activated spatial relation for the PUCCH to a previously transmitted SRS resource or to a DL RS such as SSB or CSI-RS. The same spatial filter for transmitting the indicated SRS or for achieving the best RSRP on the DL RS should be used for channel sensing and the subsequent PUCCH transmission.

According to a third variant of the embodiment 2a, the UE 100 senses the radio channel during the CCA 302 in multiple directions according to the spatial relation indicated for the subsequent UL transmission 304, i.e., using multiple antenna panels and/or multiple beamforming precoders based on one or more of the following options.

According to a first option, the UE 100 senses the channel (i.e., the shared radio spectrum) instantaneously in different directions using multiple antenna panels and/or multiple beamforming precoders. According to one implementation, the channel sensing (i.e., the CCA 302) in different directions may use the same LBT engine and/or LBT procedure. According to another implementation, channel sensing (i.e., the CCA 302) in different directions may use the different LBT engines and/or LBT procedures, respectively.

According to a second option, which may be combined with the first option, the UE 100 senses the channel (i.e., performs the CCA 302) in different directions using different antenna panels and/or different beamforming precoders in different time instances. According to a first implementation, the time instances are consecutive channel sensing durations in the LBT procedure. For example, a single sensing duration may comprise, or consist of, one or multiple sensing slots. According to a second implementation, the time instances are consecutive (e.g., short) channel sensing durations, optionally within a single sensing slot, in the LBT procedure. According to a third implementation, the time instances are separated at beam switches and/or in a COT.

According to the fourth variant of the embodiment 2a, when the UE 100 senses the radio channel (i.e., performs the CCA 302) in multiple directions, the LBT parameters for each direction may be one or more of the following options. According to a first option, the LBT parameters for each direction is independent of the LBT parameters for the other directions. According to a second option, the LBT parameters for each direction is dependent on the LBT parameters for one or each of the other directions. E.g., one direction may be selected as the primary direction (e.g., which is sensed primarily). The LBT parameters in the other directions may be dependent on the outcome and/or the type of the sensing in the primary direction.

According to the fifth variant of the embodiment 2a, when the UE 100 senses the radio channel (i.e., performs the CCA 302) in multiple directions, the UE 100 may determine the antenna panel and/or beamforming precoder used for each direction based on one or multiple of the following options.

According to a first option, the gNB 200 configures and/or signals to the UE 100 different spatial relations for different sensing directions independently, e.g., one spatial relation for each sensing direction. In a non-limiting example, the configuration of the spatial relation for the subsequent UL transmission 304 may be reused (i.e., also used) for channel sensing (i.e., the CCA 302) in multiple directions.

According to a second option, the gNB 200 configures and/or signals to the UE 100 a spatial relation for multiple sensing directions jointly, e.g., one spatial relation corresponding to and/or covering multiple sensing directions (e.g., the different directions used for the CCA 302).

According to the sixth variant of the embodiment 2a, the UE 100 is configured with a set of spatial relations for each UL signal or channel transmitted in the beamformed transmission 304, e.g., instead of a single spatial relation as described in the second or fifth variant above. The UE 100 then senses the channel (i.e., performs the CCA 302 on the shared radio spectrum) according to the plurality of spatial relations in the (e.g., active and/or configured) set according to the second or fifth variant above and/or transmits according to one of the spatial relations in the beamformed transmission 304. The sensing among the plurality of the spatial relations can be done according to the third and/or fourth variant above.

According to an embodiment 2b, which may comprise at least one or each feature of the second embodiment, channel sensing 302 for a UL transmission 304 is performed by a radio device (e.g., UE) as the transmitting station 100 without beam correspondence capability.

A UE 100 (e.g., without beam correspondence capability) may use an omni-directional or quasi-omni-directional beam (e.g., as a sensing beam) for channel sensing (i.e., for the beamformed reception of the CCA 302) prior to the UL transmission 304. The sensing beam (i.e., the beamformed reception) may cover at least the transmission direction of the subsequent UL transmission 304.

For a UE equipped with multiple antenna panels wherein the boresights of the antenna panels point at different directions, the UE performs channel sensing using the same antenna panel as the one to be used in the subsequent UL transmission 304.

To ensure that the channel sensing range (i.e., the angular of the beamformed reception of the CCA 302) covers the direction of the subsequent UL transmission 304, the UE 100 can perform channel sensing (i.e., the CCA 302) using the quasi-omni-directional beam from the antenna panel, i.e., the widest beam or beamwidth that can be created or configured by the antenna panel.

Alternatively or in addition, a UE 100 without beam correspondence capability may use a directional beam for channel sensing based on a pre-define rule, e.g., based on the beam used in the latest DL reception, or based on the beam used in the latest DL reception with the highest SINR within a certain time window.

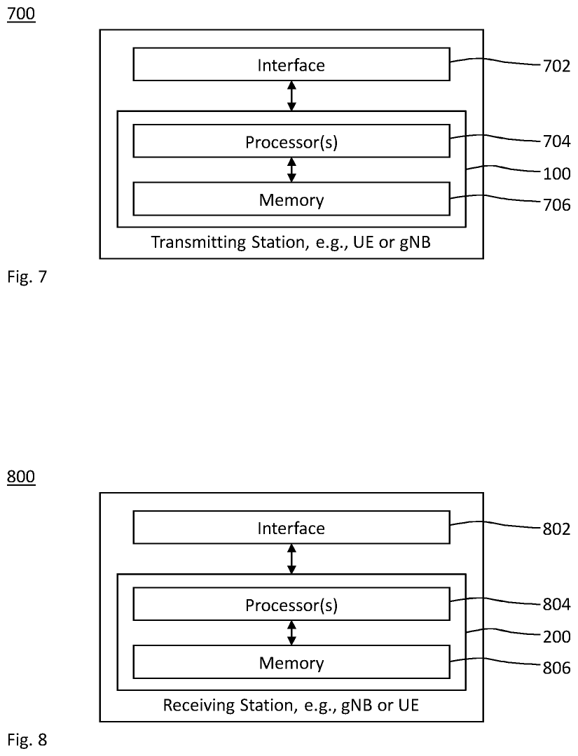

FIG. 7 shows a schematic block diagram for an embodiment of the device 100. The device 100 comprises processing circuitry, e.g., one or more processors 704 for performing the method 300 and memory 706 coupled to the processors 704. For example, the memory 706 may be encoded with instructions that implement at least one of the modules 102 and 104.

The one or more processors 704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 706, transmitter functionality. For example, the one or more processors 704 may execute instructions stored in the memory 706. Such functionality may include providing various features and steps discussed herein, including any of the benefits disclosed herein. The expression “the device being operative to perform an action” may denote the device 100 being configured to perform the action.

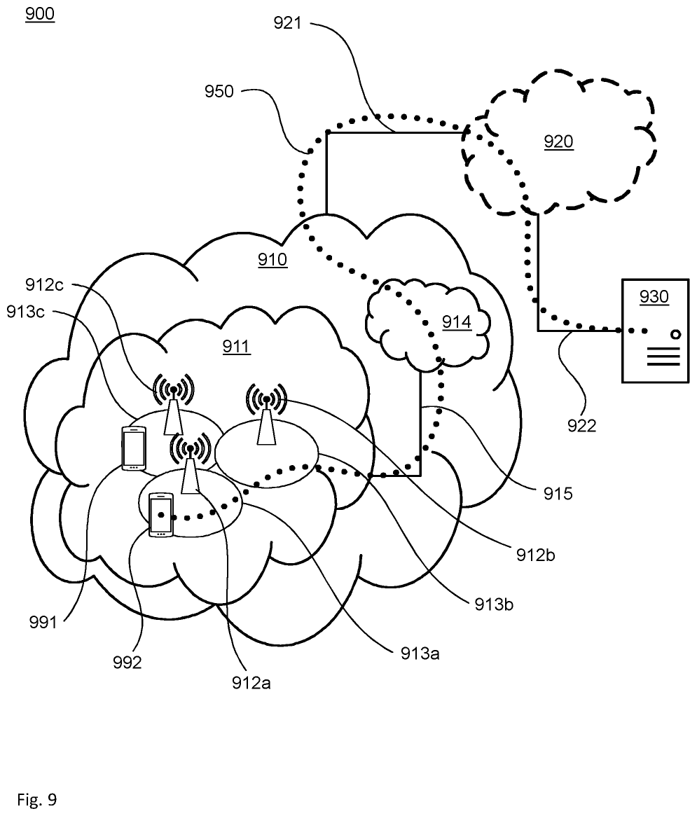

As schematically illustrated in FIG. 7, the device 100 may be embodied by a transmitting station 700, e.g., functioning as a transmitting base station or a transmitting UE. The transmitting station 700 comprises a radio interface 702 coupled to the device 100 for radio communication with one or more receiving stations, e.g., functioning as a receiving base station or a receiving UE. FIG. 8 shows a schematic block diagram for an embodiment of the device 200. The device 200 comprises processing circuitry, e.g., one or more processors 804 for performing the method 400 and memory 806 coupled to the processors 804. For example, the memory 806 may be encoded with instructions that implement at least one of the modules 202 and 204.

The one or more processors 804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 806, receiver functionality. For example, the one or more processors 804 may execute instructions stored in the memory 806. Such functionality may include providing various features and steps discussed herein, including any of the benefits disclosed herein. The expression “the device being operative to perform an action” may denote the device 200 being configured to perform the action.

As schematically illustrated in FIG. 8, the device 200 may be embodied by a receiving station 800, e.g., functioning as a receiving base station or a receiving UE. The receiving station 800 comprises a radio interface 802 coupled to the device 200 for radio communication with one or more transmitting stations, e.g., functioning as a transmitting base station or a transmitting UE.

With reference to FIG. 9, in accordance with an embodiment, a communication system 900 includes a telecommunication network 910, such as a 3GPP-type cellular network, which comprises an access network 911, such as a radio access network, and a core network 914. The access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to the core network 914 over a wired or wireless connection 915. A first user equipment (UE) 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Any of the base stations 912 and the UEs 991, 992 may embody the device 100.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. The connections 921, 922 between the telecommunication network 910 and the host computer 930 may extend directly from the core network 914 to the host computer 930 or may go via an optional intermediate network 920. The intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system 900 of FIG. 9 as a whole enables connectivity between one of the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, a base station 912 need not be informed about the past routing of an incoming downlink communication with data originating from a host computer 930 to be forwarded (e.g., handed over) to a connected UE 991. Similarly, the base station 912 need not be aware of the future routing of an outgoing uplink communication originating from the UE 991 towards the host computer 930.

By virtue of the method 100 and/or 200 being performed by any one of the UEs 991 or 992 and/or any one of the network nodes (e.g., base stations) 912, the channel capacity or range of the OTT connection 950 can be improved, e.g., in terms of increased throughput and/or reduced latency and/or reliability. More specifically, the host computer 930 may indicate to the RAN 500 (e.g., to the radio device or the network node, optionally on an application layer) a Quality of Service (QoS) or characteristic (e.g., burst-like transmission) of the traffic or service or data transmitted in the step 304, which may trigger using the technique.

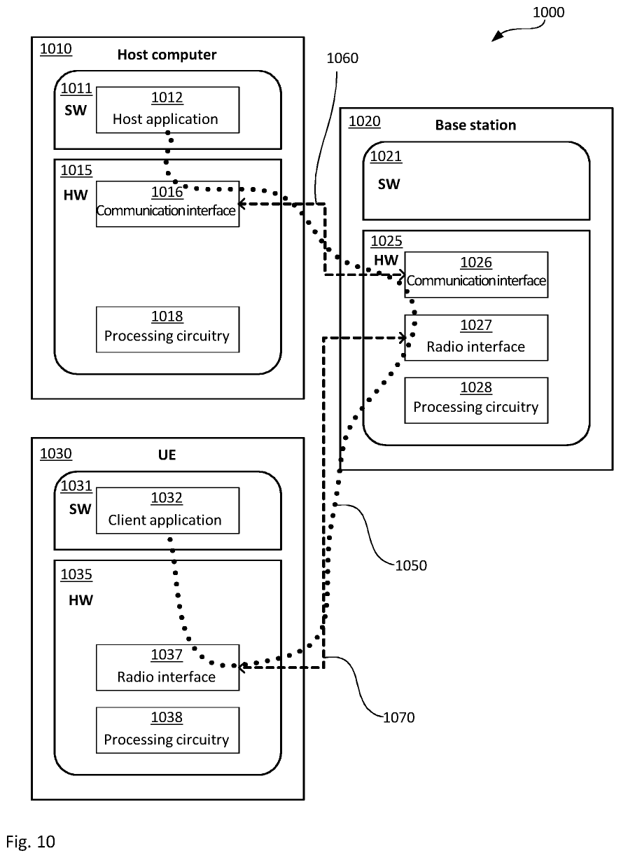

Example implementations, in accordance with an embodiment of the UE, base station and host computer discussed in the preceding paragraphs, will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 1011, which is stored in or accessible by the host computer 1010 and executable by the processing circuitry 1018. The software 1011 includes a host application 1012. The host application 1012 may be operable to provide a service to a remote user, such as a UE 1030 connecting via an OTT connection 1050 terminating at the UE 1030 and the host computer 1010. In providing the service to the remote user, the host application 1012 may provide user data, which is transmitted using the OTT connection 1050. The user data may depend on the location of the UE 1030. The user data may comprise auxiliary information or precision advertisements (also: ads) delivered to the UE 1030. The location may be reported by the UE 1030 to the host computer, e.g., using the OTT connection 1050, and/or by the base station 1020, e.g., using a connection 1060.

The communication system 1000 further includes a base station 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with a UE 1030 located in a coverage area (not shown in FIG. 10) served by the base station 1020. The communication interface 1026 may be configured to facilitate a connection 1060 to the host computer 1010. The connection 1060 may be direct, or it may pass through a core network (not shown in FIG. 10) of the telecommunication system and/or through one or more intermediate networks outside the telecommunication system. In the embodiment shown, the hardware 1025 of the base station 1020 further includes processing circuitry 1028, which may comprise one or more programmable processors, application-specific integrated circuits, field programmable gate arrays or combinations of these (not shown) adapted to execute instructions. The base station 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a base station serving a coverage area in which the UE 1030 is currently located. The hardware 1035 of the UE 1030 further includes processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, base station 1020 and UE 1030 illustrated in FIG. 10 may be identical to the host computer 930, one of the base stations 912a, 912b, 912c and one of the UEs 991, 992 of FIG. 9, respectively. This is to say, the inner workings of these entities may be as shown in FIG. 10, and, independently, the surrounding network topology may be that of FIG. 9.

In FIG. 10, the OTT connection 1050 has been drawn abstractly to illustrate the communication between the host computer 1010 and the UE 1030 via the base station 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

The wireless connection 1070 between the UE 1030 and the base station 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1050 between the host computer 1010 and UE 1030, in response to variations in the measurement results. The measurement procedure and/or the network functionality for reconfiguring the OTT connection 1050 may be implemented in the software 1011 of the host computer 1010 or in the software 1031 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of the OTT connection 1050 may include message format, retransmission settings, preferred routing etc.; the reconfiguring need not affect the base station 1020, and it may be unknown or imperceptible to the base station 1020. Such procedures and functionalities may be known and practiced in the art. In certain embodiments, measurements may involve proprietary UE signaling facilitating the host computer's 1010 measurements of throughput, propagation times, latency and the like. The measurements may be implemented in that the software 1011, 1031 causes messages to be transmitted, in particular empty or “dummy” messages, using the OTT connection 1050 while it monitors propagation times, errors etc.

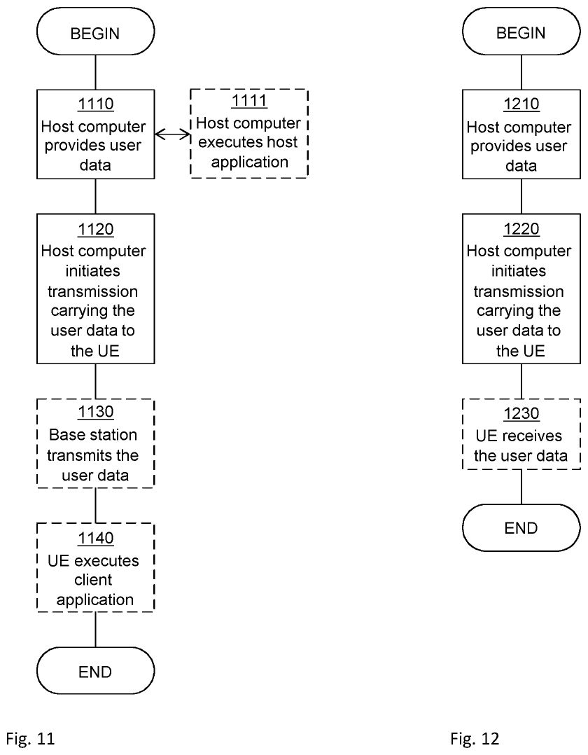

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this paragraph. In a first step 1110 of the method, the host computer provides user data. In an optional substep 1111 of the first step 1110, the host computer provides the user data by executing a host application. In a second step 1120, the host computer initiates a transmission carrying the user data to the UE. In an optional third step 1130, the base station transmits to the UE the user data which was carried in the transmission that the host computer initiated, in accordance with the teachings of the embodiments described throughout this disclosure. In an optional fourth step 1140, the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this paragraph. In a first step 1210 of the method, the host computer provides user data. In an optional substep (not shown) the host computer provides the user data by executing a host application. In a second step 1220, the host computer initiates a transmission carrying the user data to the UE. The transmission may pass via the base station, in accordance with the teachings of the embodiments described throughout this disclosure. In an optional third step 1230, the UE receives the user data carried in the transmission.

As has become apparent from above description, at least some embodiments of the technique allow for channel sensing (e.g., CCA) for NR operation in unlicensed bands above 52.6 GHz. Same or further embodiments can be specified with reasonable technical complexity and/or minimal specification changes.

The technique may be implemented by the following embodiments.

### LIST OF EMBODIMENTS

1. A method (300) of performing a beamformed transmission on shared radio spectrum at a transmitting station (100), the method (300) comprising or initiating the steps of:
performing a clear channel assessment, CCA (302), on the shared radio spectrum using an antenna array of the transmitting station (100); and
depending on a result of the CCA, selectively performing the beamformed transmission (304) on the shared radio spectrum using the antenna array from the transmitting station (100) to a receiving station (200).
The method may be performed by the transmitting station.
The CCA may be performed at the transmitting station. Alternatively or in addition, the beamformed transmission may be performed at the transmitting station.
The CCA may be performed immediately before the beamformed transmission. The result of the CCA may be indicative of whether the shared radio spectrum is occupied (i.e., busy) or unoccupied (i.e., idle).
The CCA may be part of a listen before talk (LBT) procedure. The LBT procedure may comprise initializing a backoff counter when the transmitting station has data for the beamformed transmission. If the result of the CCA indicates that the shared radio spectrum is unoccupied during a defer period, the LBT procedure may comprise decreasing the backoff counter every idle slot duration if the result of the CCA indicates that the shared radio spectrum is unoccupied during the idle slot duration.
The CCA may also be referred to as channel sensing. The shared radio spectrum may also be referred to as a shared radio channel (or briefly: shared channel or more briefly: channel).
The beamformed transmission may be performed responsive to (e.g., the result of) the CCA indicating that the shared radio spectrum is unoccupied and/or a backoff counter is equal to zero. Alternatively or in addition, according to the selectivity of the step of performing the beamformed transmission, the transmitting station may refrain from (e.g., defer and/or backoff from) the beamformed transmission, e.g., responsive to (e.g., the result of) the CCA indicating that the shared radio spectrum is occupied and/or a backoff counter is not yet equal to zero.

2. The method (300) of embodiment 1, wherein the CCA (302) comprises a beamformed reception (502) on the shared radio spectrum at the transmitting station (100) prior to the beamformed transmission (304).
The beamformed reception may also be referred to as beamformed sensing. For example, the beamformed reception does not require that data or control signaling is successfully received (e.g., successfully decoded).
The shared radio spectrum may be sensed according to the CCA in the beamformed reception. In other words, the beamformed reception may sense the shared radio spectrum during the CCA. In still other words, the CCA may be spatially restricted according to the beamformed reception.
Herein, “beamformed” (e.g., in a beamformed reception and/or a beamformed transmission) may refer to a gain depending on direction (i.e., a gain having a directional dependency), e.g., as viewed from the antenna array. For example, the beamformed reception may refer to a receiver gain depending on direction, e.g., a directional sensitivity of the antenna array used for the CCA. Alternatively or in addition, the beamformed transmission may refer to a transmitter gain depending on direction, e.g., a directional energy flux (i.e., the energy transfer per unit area per unit time) of an electromagnetic field transmitted from the antenna array during the beamformed transmission.
The directional dependency of the gain may correspond to an angular dependency. Alternatively or in addition, the directional dependency of the gain may comprise an azimuthal dependency (i.e., a horizontal angular dependency) and/or a dependency on inclination (i.e., a vertical angular dependency).
The beamformed reception may be omni-directional or quasi-omni-directional. Alternatively or in addition, a reception beamwidth of the CCA may correspond to the widest beamwidth that can be created or configured using the antenna array.
For example, the antenna array may comprise a first antenna array providing a first polarization and a second antenna array providing a second polarization perpendicular to the first polarization. The beamformed reception may be implemented by apply a first sequence of precoding weights (e.g., receiver gain coefficients) to the first antenna array and a second sequence of precoding weights (e.g., receiver gain coefficients) to the second antenna array, wherein the first sequence and the second sequence are complementary sequences, i.e., pairs of sequences with the property that their out-of-phase aperiodic autocorrelation is relatively small or equal to zero. The complementary sequences may be binary complementary sequences, bipolar complementary sequences, and/or or Golay pairs.

3. The method (300) of embodiment 1 or 2, wherein a reception beamwidth (502) of the beamformed reception of the CCA (302) is equal to or greater than a transmission beamwidth (504) of the beamformed transmission (304) from the transmitting station (100).
The transmission beamwidth may also be referred to as transmit beamwidth. Alternatively or in addition, the reception beamwidth may also be referred to as a receive beamwidth (i.e., a sensing beamwidth).

4. The method (300) of any one of embodiments 1 to 3, wherein an angular range (502) of the beamformed reception of the CCA (302) covers a transmission beam (504) of the beamformed transmission (304) from the transmitting station (100).
The transmission beam may also be referred to as transmit beam. Alternatively or in addition, the angular range of the beamformed reception may correspond to a receive beam (i.e., a sensing beam).

5. The method (300) of any one of embodiments 1 to 4, wherein a beamformed reception filter (502) is used for the beamformed reception of the CCA (302) and a beamformed transmission filter (504) is used for the beamformed transmission (304), and wherein the beamformed transmission filter (504) corresponds to the beamformed reception filter (502).
The beamformed reception filter may also be referred to as beamforming filter or spatial filter for the beamformed reception. The beamformed transmission filter may also be referred to as beamforming filter or spatial filter for the beamformed transmission. The filters may be collectively referred to as beamforming filters or spatial filters. The beamforming filter may also be referred to as a spatial filter, e.g., because beamforming may correspond to spatial filtering.
The beamformed reception filter may correspond to the beamformed transmission filter in that the same spatial filter is used for the beamformed reception of the CCA and the beamformed transmission. Alternatively or in addition, the spatial filter (or each of the spatial filters) may comprise precoding weights, e.g., one precoding weight for each antenna (e.g., each antenna element or each antenna port) of the antenna array.
The beamformed reception filter may correspond to the beamformed transmission filter in that the same or corresponding precoding weights are used for the beamformed reception of the CCA and the beamformed transmission. For example, the precoding weights used for the beamformed reception of the CCA may be complex-conjugated numbers of the precoding weights used for the beamformed transmission. The spatial filter (or each of the spatial filters) may also be referred to as a beamforming precoder (or briefly: precoder). The spatial filter for the beamformed reception may be applied downstream of the antenna array, i.e., as a spatial decoder, in contrast to the spatial filter for the beamformed transmission that may be applied upstream of the antenna array, i.e., as a spatial precoder.

6. The method (300) of any one of embodiments 1 to 5, wherein the beamformed reception (502) of the CCA (302) at the transmitting station (100) comprises at least one of energy detection; preamble detection; and virtual carrier sensing.

7. The method (300) of any one of embodiments 1 to 6, wherein the transmitting station (100) comprises multiple antenna panels, each of the multiple antenna panels comprising an antenna array, and wherein the same antenna panel is used for both the CCA (302) and the beamformed transmission (304).

8. The method (300) of any one of embodiments 1 to 7, wherein the CCA (302) comprises multiple beamformed receptions (502) on the shared radio spectrum in different directions at the transmitting station (100), optionally using at least one of:
multiple beamformed reception filters (502) directed in the different directions; and
multiple antenna panels directed in the different directions.
The different directions may correspond to a peak or a global maximum or a main lobe of the gain of the respective beamformed reception filters and/or antenna panels.

9. The method (300) of embodiment 8, wherein the CCA (302) is performed in the different directions simultaneously or sequentially.

10. The method (300) of embodiment 8 or 9, wherein multiple CCA entities perform the CCA (302) independently in the different directions.
The multiple CCA entities may be executed separately and/or at the transmitting station.

11. The method (300) of embodiment 8 or 9, wherein the same CCA entity performs the CCA (302) in the different directions.

12. The method (300) of any one of embodiments 8 to 11, wherein the beamformed transmission (304) is performed selectively according to a listen before talk, LBT, procedure, the LBT procedure comprising a backoff counter that is decreased while the result of the CCA (302) is indicative of the shared radio spectrum being unoccupied and the beamformed transmission (304) being performed responsive to the backoff counter being equal to zero.

13. The method (300) of embodiment 12, wherein the LBT procedure is performed independently for each of the different directions.

14. The method (300) of embodiment 12 or 13, wherein a backoff counter is maintained independently for each of the different directions.
A backoff counter may be maintained independently for each of the different directions. Performing the LBT procedure independently for each of the different directions may comprise decreasing backoff counters associated with the respective directions while the result of the CCA performed in the respective directions is indicative of the shared radio spectrum being unoccupied. For example, as soon as any one of the backoff counters associated with the different directions is zero, the beamformed transmission may be performed in the respective direction (e.g., according to the selectivity of the step of selectively performing the beamformed transmission).
Each of the backoff counters associated with the different directions may be initialized by a random (e.g., natural) number. Each of the backoff counters may be initialized by the same random number or by independently generated random numbers.

15. The method (300) of embodiment 12, wherein the same LBT procedure is performed for each of the different directions.

16. The method (300) of embodiment 12 or 13, wherein the same backoff counter is maintained for each of the different directions.

17. The method (300) of any one of embodiments 1 to 16, wherein at least one of the CCA (302) and the LBT procedure is performed for the different directions at different time instances, optionally in consecutive durations or in separate durations.
The (e.g., consecutive) durations may be channel sensing duration of the LBT procedure.

18. The method (300) of embodiment 17, wherein each of the consecutive durations for at least one of the CCA (302) and the LBT procedure comprises one or multiple sensing slots.
The one or more sensing slots may be sensing slots of the LBT procedure.

19. The method (300) of embodiment 17, wherein the time instances are separated in a channel occupancy time, COT, optionally at beam switches.
The COT may be a COT according to the LBT procedure. Alternatively or in addition, the beam switches may relate to switching the beamforming weights and/or the antenna panels, e.g., for the CCA being performed sequentially (e.g., consecutively) for the different directions.

20. The method (300) of any one of embodiments 1 to 19, wherein at least one of the CCA (302) and the LBT procedure comprises one or more parameters, which are configured and/or maintained independently from each other for each the different directions.

21. The method (300) of any one of embodiments 1 to 19, wherein at least one of the CCA (302) and the LBT procedure comprises one or more parameters, which are configured and/or maintained for each the different directions based on the one or more parameters for a primary direction out of the different directions.

22. The method (300) of any one of embodiments 1 to 21, wherein the beamformed transmission (304) comprises transmitting data or control signaling according to a radio access technology, RAT, of the transmitting station (100).
The RAT of the transmitting station may comprise 3GPP NR or 3GPP LTE.
The data may be transmitted in a physical downlink shared channel (PDSCH) or a physical uplink shared channel (PUSCH). Alternatively or in addition, the control signaling may be transmitted on a physical downlink control channel (PDCCH) or a physical uplink control channel (PUCCH).

23. The method (300) of any one of embodiments 1 to 22, wherein the shared radio spectrum is shared by multiple RATs comprising a RAT other than the RAT of the transmitting station (100).
The other RAT may comprise Wi-Fi.

24. The method (300) of any one of embodiments 1 to 23, wherein the beamformed transmission (304) transmits at least one of a broadcast signal; a multicast signal; a unicast signal; a synchronization signal block, SSB; a channel state information reference signal, CSI-RS; and downlink control information, DCI.
The SSB may be an SS/PBCH Block, i.e. a block comprising one or more synchronization signals (SS) and a physical broadcast channel (PBCH).

25. The method (300) of any one of embodiments 1 to 24, wherein the beamformed transmission (304) transmits at least one of a random access preamble, RAP; a physical random access channel, PRACH; a sounding reference signal, SRS; a physical uplink control channel, PUCCH; and a physical uplink shared channel, PUSCH.

26. The method (300) of any one of embodiments 1 to 25, wherein the transmitting station (100) comprises a network node of a radio access network, RAN (500), and the receiving station (200) comprises a radio device.
The network node may provide radio access to the radio device according to the RAT of the RAN.

27. The method (300) of any one of embodiments 1 to 26, wherein the beamformed transmission (304) is a downlink, DL, transmission.

28. The method (300) of any one of embodiments 1 to 25, wherein the transmitting station (100) comprises a radio device and the receiving station (200) comprises a network node of a RAN.

29. The method (300) of any one of embodiments 1 to 25 or 28, wherein the beamformed transmission (304) is an uplink, UL, transmission.

30. The method (300) of any one of embodiments 1 to 29, further comprising or initiating the step of:
determining beamforming weights, for at least one or each of the beamformed reception (502) of the CCA (302) and the beamformed transmission (304), based on a source channel (506) or a source signal (506), optionally wherein the source channel (506) or the source signal (506) is related to a channel or a signal transmitted in the beamformed transmission (304) according to a configuration of a spatial relation between the channel or the signal transmitted in the beamformed transmission (304) and the source channel (506) or the source signal (506).
The beamforming weights may be determined by maximizing a received power (e.g., a reference signal received power, RSRP) and/or a signal to noise ratio (SNR) and/or a signal to interference and noise ratio (SINR) for the source channel or the source signal.
The channel or the signal transmitted in the beamformed transmission may also be referred to as a target channel or a target signal. Herein, the terms signal, channel, and resource may be used interchangeably and/or in combination (e.g., signal resource or source SRS resource).
The source channel or the source signal may be transmitted from the transmitting station (e.g., an UL transmission or a DL transmission). Alternatively or in addition, the source channel or the source signal may be received at the transmitting station (e.g., an UL reception or a DL reception).
The precoding weights may also be referred to as beamforming weights. The precoding weights may be applied to each antenna (e.g., each antenna element and/or each antenna port) of the antenna array. The precoding weights may be collectively referred to as beamforming vector or precoding vector or precoder.
The configuration of the spatial relation may be received from the network node, optionally in response to indicating a beam correspondence to the network node.

31. The method (300) of any one of embodiments 1 to 30, wherein the beamforming weights for the beamformed transmission (304) are also used for the beamformed reception (502) of the CCA (302).
The beamforming weights to be used, e.g., according to the beam correspondence (i.e., the spatial relation), for the beamformed transmission may also be used for the beamformed reception of the CCA.

32. The method (300) of any one of embodiments 1 to 31, wherein at least one or each of the beamformed reception (502) of the CCA (302) and the beamformed transmission (304) uses beamforming weights determined based on an SSB, optionally wherein the beamforming transmission (304) comprises a PRACH transmission.
The beamformed transmission may comprise a PRACH transmission. The PRACH transmission may be related to the SSB, e.g., according to the beam correspondence (i.e., according to the configured spatial relation).
The SSB may be the source signal. Alternatively or in addition, the SSB may be received from the network node of the RAN serving the radio device.
The beamforming weights may be determined by maximizing a reference signal received power (RSRP) of the SSB at the transmitting station.

33. The method (300) of any one of embodiments 1 to 32, wherein at least one or each of the beamformed reception (502) of the CCA (302) and the beamformed transmission (304) uses beamforming weights determined for a previously transmitted SRS or determined based on a downlink reference signal or an SSB, optionally wherein the beamforming transmission (304) transmits a SRS.

34. The method (300) of any one of embodiments 1 to 33, wherein at least one or each of the beamformed reception (502) of the CCA (302) and the beamformed transmission (304) uses beamforming weights determined for a previously transmitted SRS or determined based on a downlink reference signal or an SSB, optionally wherein the beamforming transmission (304) comprises a PUSCH transmission.

35. The method (300) of any one of embodiments 1 to 34, wherein at least one or each of the beamformed reception (502) of the CCA (302) and the beamformed transmission (304) uses beamforming weights determined for a previously transmitted SRS or determined based on a downlink reference signal or an SSB or a CSI-RS, optionally wherein the beamforming transmission (304) comprises a PUCCH transmission.

36. The method (300) of any one of embodiments 1 to 35, further comprising or initiating the step of:
transmitting or receiving at least one configuration message (506) that is indicative of the configuration of the spatial relation.
The configuration message may be transmitted from the radio device to the network node or may be received from the network node at the radio device.
The configuration message may be a downlink control information (DCI), e.g., wherein the beamformed transmission is based on a dynamic scheduling (e.g., by the network node). Alternatively or in addition, the configuration message may be radio resource control (RRC) signaling (i.e., a RRC configuration), e.g., wherein the beamformed transmission is based on a configured grant (CG) of Type-1. Alternatively or in addition, the configuration message may be an activating DCI (e.g., an UL DCI, i.e., a DCI relating to an UL transmission), e.g., wherein the beamformed transmission is based on a configured grant (CG) of Type-2.

37. The method (300) of embodiment 36, wherein the at least one configuration message (506) is indicative of the configuration of different spatial relations for the different directions, optionally a different spatial relation for each of the different directions for which the CCA (302) is performed.

38. The method (300) of embodiment 36, wherein the at least one configuration message (506) is indicative of the configuration of one spatial relation for the different directions, optionally one spatial relation for each of the different directions for which the CCA (302) is performed.
The transmitting station may be a radio device without beam correspondence capability and/or without indicating beam correspondence capability to the network node.

39. The method (300) of any one of embodiments 1 to 38, further comprising or initiating the step of:
determining beamforming weights for at least one or each of the beamformed reception of the CCA (302) and the beamformed transmission (304) based on the latest reception from the receiving station (200), optionally by maximizing the SINR in the latest reception from the receiving station (200).

40. A method (400) of configuring a transmitting station (100) for a beamformed transmission on shared radio spectrum, the method (400) comprising or initiating the steps of:
transmitting (402) at least one of a source signal (506) for determining beamforming weights based on the source signal and a configuration message (506) indicative of a configuration for determining the beamforming weights based on the source signal, wherein at least one of the source signal (506) and the configuration message (506) configures the transmitting station (100) to determine beamforming weights for a beamformed reception (502) of a clear channel assessment, CCA, on the shared radio spectrum; and
receiving (404) the beamformed transmission on the shared radio spectrum from the transmitting station (100) at a receiving station (200) depending on a result of the CCA.
The method may be performed by the receiving station.

41. The method (300) of embodiment 40, wherein the beamforming weights are also used for the beamformed transmission (404).

42. The method of embodiment 40 or 41, further comprising the features or steps of any one of embodiments 2 to 39 or any feature or step corresponding thereto.

43. A computer program product comprising program code portions for performing the steps of any one of the embodiments 1 to 39 or 40 to 42 when the computer program product is executed on one or more computing devices (1104; 1204), optionally stored on a computer-readable recording medium (1106; 1206).

44. A transmitting station (100; 700; 912; 991; 992; 1020; 1030) for performing a beamformed transmission on shared radio spectrum at the transmitting station (100), the transmitting station (100) comprising memory operable to store instructions and processing circuitry operable to execute the instructions, such that the transmitting station (100) is operable to:
perform a clear channel assessment, CCA (302), on the shared radio spectrum using an antenna array of the transmitting station (100); and
depending on a result of the CCA, selectively perform the beamformed transmission (304) on the shared radio spectrum using the antenna array from the transmitting station (100) to a receiving station (200).

45. The transmitting station (100; 700; 912; 991; 992; 1020; 1030) of embodiment 44, further operable to perform the steps of any one of embodiments 2 to 39.

46. A transmitting station (100; 700; 912; 991; 992; 1020; 1030) for performing a beamformed transmission on shared radio spectrum at the transmitting station (100), configured to:
perform a clear channel assessment, CCA (302), on the shared radio spectrum using an antenna array of the transmitting station (100); and
depending on a result of the CCA, selectively perform the beamformed transmission (304) on the shared radio spectrum using the antenna array from the transmitting station (100) to a receiving station (200).

47. The transmitting station (100; 700; 912; 991; 992; 1020; 1030) of embodiment 46, further configured to perform the steps of any one of embodiments 2 to 39.

48. A user equipment, UE, (100; 200; 700; 800; 991; 992; 1030) configured to communicate with a network node (200; 100; 800; 700; 912; 1020) or with a radio device functioning as a gateway, the UE (100; 200; 700; 800; 991; 992; 1030) comprising a radio interface (702; 802; 1037) and processing circuitry (704; 804; 1038) configured to perform the steps of any one of the embodiments 1 to 39 or 40 to 42.

49. A receiving station (200; 800; 912; 991; 992; 1020; 1030) for configuring a transmitting station (100) for a beamformed transmission on shared radio spectrum, the receiving station (200; 800; 912; 991; 992; 1020; 1030) comprising memory operable to store instructions and processing circuitry operable to execute the instructions, such that the receiving station (200; 800; 912; 991; 992; 1020; 1030) is operable to:
transmit (402) at least one of a source signal (506) for determining beamforming weights based on the source signal and a configuration message (506) indicative of a configuration for determining the beamforming weights based on the source signal, wherein at least one of the source signal (506) and the configuration message (506) configures the transmitting station (100) to determine beamforming weights for a beamformed reception (502) of a clear channel assessment, CCA, on the shared radio spectrum; and receive (404) the beamformed transmission on the shared radio spectrum from the transmitting station (100) at a receiving station (200) depending on a result of the CCA.

50. The receiving station (200; 800; 912; 991; 992; 1020; 1030) of embodiment 49, further operable to perform any one of the steps of any one of embodiments 41 to 42.

51. A receiving station (200; 800; 912; 991; 992; 1020; 1030) for configuring a transmitting station (100) for a beamformed transmission on shared radio spectrum, configured to:
transmit (402) at least one of a source signal (506) for determining beamforming weights based on the source signal and a configuration message (506) indicative of a configuration for determining the beamforming weights based on the source signal, wherein at least one of the source signal (506) and the configuration message (506) configures the transmitting station (100) to determine beamforming weights for a beamformed reception (502) of a clear channel assessment, CCA, on the shared radio spectrum; and
receive (404) the beamformed transmission on the shared radio spectrum from the transmitting station (100) at a receiving station (200) depending on a result of the CCA.

52. The receiving station (200; 800; 912; 991; 992; 1020; 1030) of embodiment 51, further configured to perform the steps of any one of embodiment 41 to 42.

53. A network node (200; 100; 800; 700; 912; 1020) configured to communicate with a user equipment, UE (100; 200; 700; 800; 991; 992; 1030), the network node (200; 100; 800; 700; 912; 1020) comprising a radio interface (1202; 1427) and processing circuitry (1204; 1428) configured to perform the steps of any one of the embodiments 1 to 39 or 40 to 42.
The network node may be a base station.

54. A communication system (500; 900; 1000) including a host computer (930; 1010) comprising:
processing circuitry (1018) configured to provide user data; and
a communication interface (1016) configured to forward user data to a cellular or ad hoc radio network (500; 910) for transmission to a user equipment, UE, (100; 200; 700; 800; 991; 992; 1030) wherein the UE (100; 200; 700; 800; 991; 992; 1030) comprises a radio interface (702; 802; 1037) and processing circuitry (1104; 1438), the processing circuitry (704; 804; 1038) of the UE (100; 200; 700; 800; 991; 992; 1030) being configured to execute the steps of any one of embodiments 1 to 39 or 40 to 42.

55. The communication system (500; 900; 1000) of embodiment 54, further including the UE (100; 200; 700; 800; 991; 992; 1030).

56. The communication system (500; 900; 1000) of embodiment 54 or 55, wherein the radio network (1310) further comprises a network node (200; 100; 800; 700; 912; 1020), or a radio device functioning as a gateway, which is configured to communicate with the UE (100; 200; 700; 800; 991; 992; 1030).

57. The communication system (500; 900; 1000) of embodiment 56, wherein the network node (200; 100; 800; 700; 912; 1020), or the radio device functioning as a gateway, comprises processing circuitry (1204; 1428), which is configured to execute the steps of embodiment 1 to 39 or 40 to 42.

58. The communication system (500; 900; 1000) of any one of embodiments 54 to 57, wherein:
the processing circuitry (1018) of the host computer (1330; 1410) is configured to execute a host application (1012), thereby providing the user data; and
the processing circuitry (704; 804; 1038) of the UE (100; 1100; 1391; 1392; 1430) is configured to execute a client application (1032) associated with the host application (1012).

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1-58. (canceled)

59. A method of performing a beamformed transmission on shared radio spectrum at a user equipment (UE), the method comprising:
performing a clear channel assessment (CCA) on the shared radio spectrum using an antenna array of the UE, wherein the CCA comprises a beamformed reception on the shared radio spectrum at the UE prior to the beamformed transmission; and
depending on a result of the CCA, selectively performing the beamformed transmission on the shared radio spectrum using the antenna array from the UE to a receiving station, wherein said selectively performing the beamforming comprises, when the UE indicates a capability of beam correspondence, a reception beamwidth of the beamformed reception being equal to a transmission beamwidth of the beamformed transmission, and when the UE is a UE without beam correspondence capability, the reception beamwidth of the beamformed reception covering at least the transmission beamwidth of the beamformed transmission.

60. The method of claim 59, further comprising at least one of:
determining beamforming weights, for a beamformed reception of a clear channel assessment (CCA) and the beamformed transmission, based on a source channel or a source signal;
indicating the capability of beam correspondence.

61. The method of claim 60, wherein the beam correspondence is a capability of the UE that the UE indicates to a network node via capability reporting and/or wherein the UE indicates the capability of the beam correspondence by transmitting a control signaling to a network node.

62. The method of claim 60, wherein a beamformed reception filter is used for the beamformed reception of the CCA and a beamformed transmission filter is used for the beamformed transmission, and wherein the beamformed transmission filter corresponds to the beamformed reception filter, and/or
wherein the beamforming weights for the beamformed transmission are also used for the beamformed reception of the CCA.

63. The method of claim 60, wherein the same beamforming weights for transmitting an indicated SRS resource or the indicated SRS resource is used for the CCA and the subsequent transmission.

64. The method of claim 60, wherein the transmission is transmitted using the same beamforming weights as an associated SRS resource.

65. The method of claim 59, wherein the CCA comprises multiple beamformed receptions on the shared radio spectrum in different directions at the UE.

66. The method of claim 65, where the multiple beamformed receptions use at least one of:
multiple beamformed reception filters directed in the different directions; and
multiple antenna panels directed in the different directions.

67. A user equipment (UE), for performing a beamformed transmission on shared radio spectrum at the UE, the UE comprising radio circuitry and processing circuitry configured to:
perform a clear channel assessment (CCA) on the shared radio spectrum using an antenna array of the UE, wherein the CCA comprises a beamformed reception on the shared radio spectrum at the UE prior to the beamformed transmission; and
depending on a result of the CCA, selectively perform the beamformed transmission on the shared radio spectrum using the antenna array from the UE to a receiving station, wherein selectively performing the beamformed transmission comprises, when the UE indicates a capability of beam correspondence, a reception beamwidth of the beamformed reception being equal to a transmission beamwidth of the beamformed transmission and, when the UE is a UE without beam correspondence capability, the reception beamwidth of the beamformed reception covering at least the transmission beamwidth of the beamformed transmission.

68. The UE of claim 67, wherein the radio circuitry and processing circuitry are configured to:
determine beamforming weights, for a beamformed reception of a clear channel assessment (CCA) and the beamformed transmission, based on a source channel or a source signal; and/or
indicate the capability of beam correspondence.

69. The UE of claim 68, wherein the beam correspondence is a capability of the UE that the UE indicates to a network node via capability reporting and/or wherein the radio circuitry and processing circuitry are configured to indicate the capability of the beam correspondence by transmitting a control signaling to a network node.

70. The UE of claim 68, wherein the radio circuitry and processing circuitry are configured so that a beamformed reception filter is used for the beamformed reception of the CCA and a beamformed transmission filter is used for the beamformed transmission, and wherein the beamformed transmission filter corresponds to the beamformed reception filter, and/or
wherein the radio circuitry and processing circuitry are configured to use the beamforming weights for the beamformed transmission also for the beamformed reception of the CCA.

71. The UE of claim 68, wherein the radio circuitry and processing circuitry are configured to use the same beamforming weights for transmitting an indicated SRS resource or to use the indicated SRS resource for the CCA and the subsequent transmission.

72. The UE of claim 68, wherein the radio circuitry and processing circuitry are configured to transmit the transmission using the same beamforming weights as an associated SRS resource.

73. The UE of claim 67, wherein the CCA comprises multiple beamformed receptions on the shared radio spectrum in different directions at the UE.

74. The UE of claim 73, where the multiple beamformed receptions use at least one of:
multiple beamformed reception filters directed in the different directions; and
multiple antenna panels directed in the different directions.
